(19) United States
(12) Patent Application Publication
(10) Pub. No.: US 2021/0053578 A1
(43) Pub. Date: Feb. 25, 2021

(54) CONTROL APPARATUS FOR VEHICLE, LEARNING SYSTEM FOR VEHICLE, AND CONTROL METHOD FOR VEHICLE

(71) Applicant: TOYOTA JIDOSHA KABUSHIKI KAISHA, Toyota-shi (JP)

(72) Inventors: Yohsuke HASHIMOTO, Nagakute-shi (JP); Akihiro KATAYAMA, Toyota-shi (JP); Yuta OSHIRO, Nagoya-shi (JP); Kazuki SUGIE, Toyota-shi (JP); Naoya OKA, Nagakute-shi (JP)

(73) Assignee: TOYOTA JIDOSHA KABUSHIKI KAISHA, Toyota-shi (JP)

(21) Appl. No.: 16/996,460

(22) Filed: Aug. 18, 2020

(30) Foreign Application Priority Data
Aug. 22, 2019 (JP) 2019-152135

(51) Int. Cl. B60W 50/04; B60W 10/06; B60W 40/02; B60W 40/105; G06N 3/08

(52) U.S. Cl. CPC B60W 50/045; B60W 10/06; B60W 2050/0026; B60W 40/105; G06N 3/08; B60W 40/02

(57) ABSTRACT

A control apparatus for a vehicle includes: a memory configured to store map data, the map data including data that defines a map and that have been trained through machine learning, the map being configured to input data based on a detected value of an in-vehicle sensor and output an output value having information about a prescribed status of the vehicle; and a processor configured to execute an acquisition process of acquiring the input data and related data different from the input data, execute a calculation process of calculating the output value by using the input data, acquired through the acquisition process, as an input to the map, and execute a sending process of sending, to an outside of the vehicle, the input data used to calculate the output value and the related data acquired through the acquisition process together with the input data.

### INCORPORATION BY REFERENCE

The disclosure of Japanese Patent Application No. 2019-152135 filed on Aug. 22, 2019 including the specification, drawings and abstract is incorporated herein by reference in its entirety.

### BACKGROUND

### 1. Technical Field

The disclosure relates to a control apparatus for a vehicle, a learning system for a vehicle, and a control method for a vehicle.

### 2. Description of Related Art

For example, Japanese Unexamined Patent Application Publication No. 4-091348 (JP 4-091348 A) suggests an apparatus including a neural network that inputs a rotation variation that is a change in the amount of rotation speed and outputs values each indicating whether a misfire has occurred in an associated one of a plurality of cylinders of an internal combustion engine.

### SUMMARY

Generally, to improve the reliability of a trained model trained through machine learning, a neural network needs to be trained in advance by using training data in various situations. However, before the neural network is installed in a vehicle, the neural network cannot always obtain sufficient training data in various situations that can occur when the neural network is actually installed in a vehicle. When the neural network cannot obtain sufficient training data, it may be difficult to check whether the neural network outputs correct values in various situations when installed in a vehicle.

A first aspect of the disclosure relates to a control apparatus for a vehicle. The control apparatus includes a memory and a processor. The memory is configured to store map data. The map data includes data that defines a map and that have been trained through machine learning. The map is configured to input data based on a detected value of an in-vehicle sensor and output an output value having information about a prescribed status of the vehicle. The processor is configured to execute an acquisition process of acquiring the input data and related data different from the input data. The processor is configured to execute a calculation process of calculating the output value by using the input data, acquired through the acquisition process, as an input to the map. The processor is configured to execute a sending process of sending, to an outside of the vehicle, the input data used to calculate the output value and the related data acquired through the acquisition process together with the input data.

With the above configuration, in addition to the output value that is calculated by the processor as the vehicle travels, the related data different from the input data is sent to the outside of the vehicle. For this reason, the validity of the map can be checked while related data is used outside the vehicle.

In the control apparatus, the related data may include a value of a positional information variable that is a variable indicating positional information of the vehicle. A situation in which the vehicle is used varies among regions, and there are concerns that various factors affect the accuracy of the output value of the map. With the above configuration, by including the value of the positional information variable in the related data, the validity of the map can be checked based on various factors peculiar to regions.

In the control apparatus, the related data may include a value of an environment variable that is a variable indicating an environment around the vehicle. Depending on an environment around the vehicle, there are concerns that various factors affect the accuracy of the output value of the map. With the above configuration, by including the value of the environment variable in the related data, the validity of the map can be checked based on various factors due to an environment.

The vehicle may include an internal combustion engine. In the control apparatus, the prescribed status may be a status of the internal combustion engine. The environment variable may include an intake air temperature variable that is a variable indicating an intake air temperature.

A combustion state, or the like, of air-fuel mixture in a combustion chamber of the internal combustion engine varies according to an intake air temperature. With the above configuration, by including the value of the intake air temperature variable in the related data, the validity of the map can be checked based on an intake air temperature.

In the control apparatus, the prescribed status may be a status of the internal combustion engine. The environment variable may include an atmospheric pressure variable that is a variable indicating an atmospheric pressure.

Because the pressure in an exhaust passage varies with an atmospheric pressure and other reasons, an atmospheric pressure can affect a combustion state of air-fuel mixture in a combustion chamber. With the above configuration, by including the value of the atmospheric pressure variable in the related data, the validity of the map can be checked based on an atmospheric pressure.

The in-vehicle sensor may include a crank angle sensor. The input data may include a value of a rotation waveform variable that is a variable containing information about a difference between values of instantaneous speeds in different angular intervals that are less than an interval of appearance of a compression top dead center of the internal combustion engine. The instantaneous speeds each may be a rotation speed of a crankshaft of the internal combustion engine in an associated one of the angular intervals. The environment variable may include a road surface condition variable indicating a condition of a road surface on which the vehicle is traveling.

Because the rotation behavior of the crankshaft can vary depending on the condition of a road surface, the rotation waveform variable may be affected by the condition of a road surface. For this reason, the output value of the map may be affected by the condition of a road surface. With the above configuration, by including the value of the road surface condition variable in the related data, the validity of the map can be checked based on the condition of a road surface.

In the control apparatus, the related data may include a value of an operating status variable that is a variable indicating an operating status of the vehicle. With the above configuration, by including the value of the operating status variable in the related data, the validity of the map that outputs the output value having information about the prescribed status of the vehicle can be checked based on the operating status of the vehicle.

In the control apparatus, the operating status variable may include a mode variable that is a variable indicating a combustion control mode of the internal combustion engine. When the combustion control mode varies, the combustion state of air-fuel mixture in a combustion chamber of the internal combustion engine also varies, so this may affect the accuracy of the output value having information about the status of the internal combustion engine. With the above configuration, by including the value of the mode variable in the related data, whether the accuracy of the output value varies with the combustion control mode can be checked.

The vehicle may include a transmission configured to change a speed ratio that is a ratio of an output-side rotation speed to a rotation speed of a crankshaft of the internal combustion engine. In the control apparatus, the in-vehicle sensor may include a crank angle sensor. The operating status variable may include a speed ratio variable that is a variable indicating a speed ratio of the transmission.

Because the moment of inertia from the crankshaft to drive wheels varies according to a speed ratio, the rotation behavior of the crankshaft varies. For this reason, the accuracy of the output value of the map to which input data based on the output value of the crank angle sensor is input may vary according to a speed ratio. In this regard, with the above configuration, by including the value of the speed ratio variable in the related data, the validity of the map can be checked based on a speed ratio.

An internal combustion engine including a catalyst in an exhaust passage may be mounted on the vehicle. In the control apparatus, information about the prescribed status may be information about a temperature of the catalyst. The operating status variable may include a vehicle speed variable that is a variable indicating a travel speed of the vehicle.

Because the temperature of the catalyst is affected by air flow while traveling, the accuracy of the output value of the map having information about the temperature of the catalyst may be affected by a vehicle speed. In this regard, with the above configuration, by including the value of the vehicle speed variable in the related data, the validity of the map can be checked based on a vehicle speed.

In the control apparatus, the map may be a second map, the map data may be second map data, the input data may be second input data, the output value may be a second output value, the acquisition process may be a second acquisition process, and the calculation process may be a second calculation process. The memory may be configured to store first map data that is data that defines a first map. The first map may use first input data based on a detected value of the in-vehicle sensor as an input and output a first output value that is an output value containing information about the prescribed status. The processor may be configured to execute a first acquisition process of acquiring the first input data based on the detected value of the in-vehicle sensor. The processor may be configured to execute a first calculation process of calculating the first output value by using the first input data acquired through the first acquisition process as an input to the first map. The processor may be configured to execute a determination process of determining whether the first output value and the second output value match. The processor may be configured to execute the sending process when the processor determines through the determination process that the first output value and the second output value do not match.

In the above configuration, when the processor determines through the determination process that the first and second output values do not match, there is a high possibility that the validity of the output value of the second map is low as compared to when the processor determines that the first and second output values match. In this regard, with the above configuration, by executing the sending process when the processor determined through the determination process that the first and second output values do not match, the sending process can be executed when it is particularly desired to check the validity of the second output value while a communication load is reduced.

A second aspect of the disclosure relates to a learning system for a vehicle. The learning system includes the above-described processor that is a first processor, the memory, and a second processor different from an in-vehicle device. The second processor is configured to execute a reception process of receiving data sent by the first processor through the sending process. The second processor is configured to execute a re-training data generation process of generating re-training data based on the data received through the reception process. The re-training data is data for re-training the map. The second processor is configured to execute a re-training process of re-training the map data based on the re-training data generated through the re-training data generation process.

With the above configuration, by re-training map data based on new input data that occurs as the vehicle travels, the map data can be brought close to map data that can deal with various situations in which the vehicle travels.

The fact that the second processor is different from an in-vehicle device means that the second processor is not an in-vehicle device.

In the learning system, the second processor may be configured to execute a map data sending process of sending the map data re-trained through the re-training process to the vehicle. The first processor may be configured to execute a map data reception process of receiving the map data sent by the second processor through the map data sending process.

With the above configuration, by receiving map data re-trained in the vehicle, map data that is used to calculate the output value can be updated in the vehicle.

A third aspect of the disclosure relates to a control method for a vehicle. The control method includes: storing map data by a memory, the map data including data that defines a map and that have been trained through machine learning, the map being configured to use input data based on a detected value of an in-vehicle sensor as an input and output an output value having information about a prescribed status of a vehicle; storing map data by a memory, the map data including data that defines a map and that have been trained through machine learning, the map being configured to use input data based on a detected value of an in-vehicle sensor as an input and output an output value having information about a prescribed status of a vehicle; executing, by the processor, a calculation process of calculating the output value by using the input data, acquired through the acquisition process, as an input to the map; and executing, by the processor, a sending process of sending, to an outside of the vehicle, the input data used to calculate the output value and the related data acquired through the acquisition process together with the input data.

In the control method, the related data may include a value of a positional information variable that is a variable indicating positional information of the vehicle.

In the control method, the related data may include a value of an environment variable that is a variable indicating an environment around the vehicle.

In the control method, the map may be a second map, the map data may be second map data, the input data may be second input data, the output value may be a second output value, the acquisition process may be a second acquisition process, and the calculation process may be a second calculation process. The control method may further include: storing, by the memory, first map data that is data that defines a first map, the first map uses first input data based on a detected value of the in-vehicle sensor as an input and outputs a first output value that is an output value containing information about the prescribed status; executing, by the processor, a first acquisition process of acquiring the first input data based on the detected value of the in-vehicle sensor; executing, by the processor, a first calculation process of calculating the first output value by using the first input data acquired through the first acquisition process as an input to the first map; executing, by the processor, a determination process of determining whether the first output value and the second output value match; and executing, by the processor, the sending process when the processor determines through the determination process that the first output value and the second output value do not match.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram that shows the configuration of a learning system for a vehicle according to a first embodiment;

FIG. 2 is a flowchart that shows the procedure of a process that a control apparatus according to the first embodiment executes;

FIG. 3 is a flowchart that shows the procedure of a process that the control apparatus according to the first embodiment executes;

FIG. 4 is a flowchart that shows the procedure of a process that a system according to the first embodiment executes;

FIG. 5 is a view that shows sending data according to the first embodiment;

FIG. 6 is a flowchart that shows the procedure of a process that the system according to the first embodiment executes;

FIG. 7 is a view that illustrates a process of dividing map data according to the first embodiment;

FIG. 8 is a view that illustrates the process of dividing map data according to the first embodiment;

FIG. 9 is a view that illustrates the process of dividing map data according to the first embodiment;

FIG. 10 is a block diagram that shows a process that a learning system for a vehicle according to a second embodiment executes;

FIG. 11 is a block diagram that shows a process that a learning system for a vehicle according to a third embodiment executes;

FIG. 12 is a block diagram that shows a process that a learning system for a vehicle according to a fourth embodiment executes; and

FIG. 13 is a block diagram that shows a process that a learning system for a vehicle according to a fifth embodiment executes.

### DETAILED DESCRIPTION OF EMBODIMENTS

### First Embodiment

Hereinafter, a first embodiment of a learning system for a vehicle will be described with reference to the accompanying drawings.

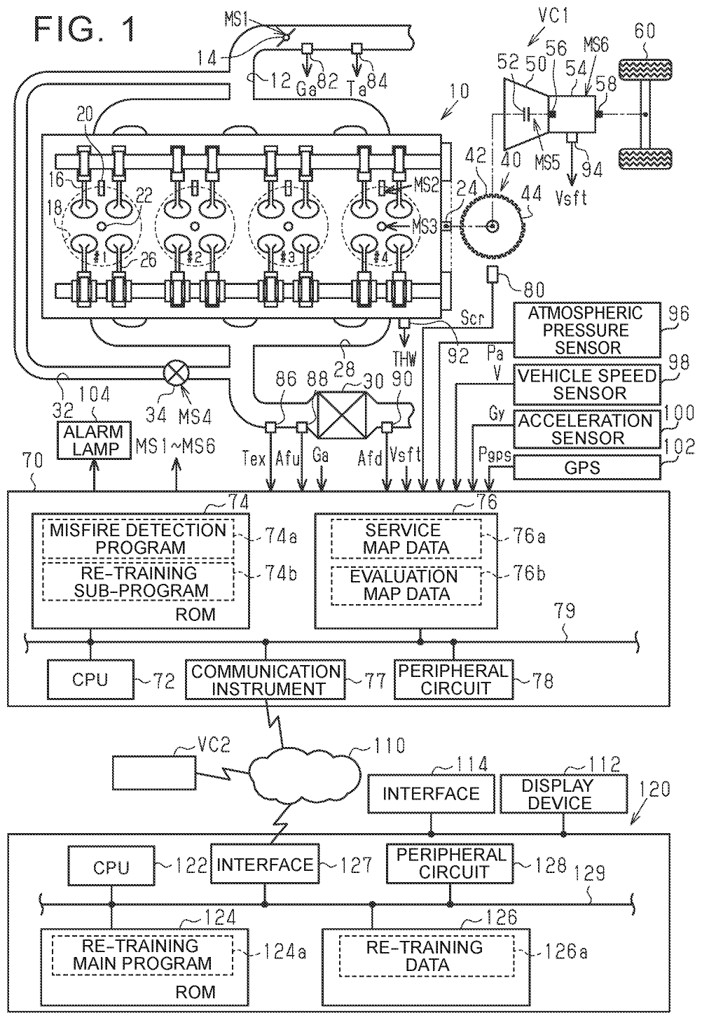

In an internal combustion engine 10 mounted on a vehicle VC1 shown in FIG. 1, a throttle valve 14 is provided in an intake passage 12. Air taken in through the intake passage 12 flows into a combustion chamber 18 of each of cylinders #1, #2, #3, #4 when an associated one of pairs of intake valves 16 opens. Fuel is injected by a fuel injection valve 20 into each combustion chamber 18. In each combustion chamber 18, air-fuel mixture of air and fuel is subjected to combustion by spark discharge of an ignition device 22, and energy generated by the combustion is taken out as the rotational energy of a crankshaft 24. Air-fuel mixture subjected to combustion is emitted to an exhaust passage 28 as exhaust gas as an associated one of pairs of exhaust valves 26 opens. A catalyst 30 having an oxygen storage capability is provided in the exhaust passage 28. The intake passage 12 and the exhaust passage 28 are connected by an EGR passage 32. The flow sectional area of the EGR passage 32 is adjusted with an EGR valve 34.

An input shaft 56 of a transmission 54 can be coupled to the crankshaft 24 of the internal combustion engine 10 via a torque converter 50. The torque converter 50 includes a lockup clutch 52. When the lockup clutch 52 is engaged, the crankshaft 24 and the input shaft 56 are coupled to each other. Drive wheels 60 are mechanically coupled to an output shaft 58 of the transmission 54.

A crank rotor 40 is connected to the crankshaft 24. The crank rotor 40 has tooth portions 42 that respectively indicate multiple rotation angles of the crankshaft 24. In the present embodiment, the number of the tooth portions 42 illustrated is 34. The crank rotor 40 basically has the tooth portions 42 at an interval of 10° CA; however, the crank rotor 40 has a toothless portion 44 that is a portion at which the interval between the adjacent tooth portions 42 is 30° CA. This is to indicate a reference rotation angle of the crankshaft 24.

A control apparatus 70 controls the internal combustion engine 10 as a controlled object and operates operating parts of the internal combustion engine 10 such as the throttle valve 14, the fuel injection valves 20, the ignition devices 22, and the EGR valve 34 to control torque, exhaust component ratio, and the like, as controlled variables of the internal combustion engine 10. The control apparatus 70 controls the torque converter 50 as a controlled object and operates the lockup clutch 52 to control the engagement status of the lockup clutch 52 as a controlled variable of the torque converter 50. The control apparatus 70 controls the transmission 54 as a controlled object and operates the transmission 54 to control a gear ratio as a controlled variable of the transmission 54. FIG. 1 shows operating signals MS1, MS2, MS3, MS4, MS5, MS6 respectively for the throttle valve 14, the fuel injection valves 20, the ignition devices 22, the EGR valve 34, the lockup clutch 52, and the transmission 54.

When the control apparatus 70 controls the controlled variables, the control apparatus 70 reads an output signal Scr of a crank angle sensor 80, an intake air volume Ga, and the temperature of intake air (intake air temperature Ta) that is taken into the intake passage 12. The crank angle sensor 80 outputs a pulse at every angular interval between any adjacent tooth portions 42 provided at intervals of 10° CA except the toothless portion 44. The intake air volume Ga is detected by an air flow meter 82. The intake air temperature Ta is detected by an intake air temperature sensor 84. The control apparatus 70 reads the temperature of exhaust gas (exhaust gas temperature Tex) that flows into the catalyst 30, an upstream air-fuel ratio Afu, and a downstream air-fuel ratio Afd. The exhaust gas temperature Tex is detected by an exhaust gas temperature sensor 86. The upstream air-fuel ratio Afu is detected by an upstream air-fuel ratio sensor 88 provided upstream of the catalyst 30. The downstream air-fuel ratio Afd is detected by a downstream air-fuel ratio sensor 90 provided downstream of the catalyst 30. The control apparatus 70 reads the temperature of coolant (coolant temperature THW) in the internal combustion engine 10, the shift position Vsft of the transmission 54, and an atmospheric pressure Pa. The coolant temperature THW is detected by a coolant temperature sensor 92. The shift position Vsft is detected by a shift position sensor 94. The atmospheric pressure Pa is detected by an atmospheric pressure sensor 96. The control apparatus 70 reads the travel speed of the vehicle VC1 (vehicle speed V), an acceleration Gy in the up-down direction of the vehicle VC1, and position data Pgps. The vehicle speed V is detected by a vehicle speed sensor 98. The acceleration Gy is detected by an acceleration sensor 100. The position data Pgps is provided by a global positioning system (GPS) 102.

The control apparatus 70 includes a CPU 72, a ROM 74, a memory 76 that is an electrically rewritable nonvolatile memory, a communication instrument 77, and a peripheral circuit 78, which are communicable through a local network 79. The peripheral circuit 78 includes a circuit that generates a clock signal regulating internal operations, a power supply circuit, a reset circuit, and the like. The memory 76 stores service map data 76a and evaluation map data 76b. The service map data 76a is data that is actually used to keep a watch on the internal combustion engine 10 for a misfire. In contrast to this, the evaluation map data 76b is data of which the reliability is to be evaluated and is not used to keep a watch on the internal combustion engine 10 for a misfire. The evaluation map data 76b is installed in the control apparatus 70 in a state where the evaluation map data 76b has been trained to a certain degree through machine learning.

The control apparatus 70 controls the controlled variables by the CPU 72 running a program stored in the ROM 74. For example, the CPU 72 operates the fuel injection valves 20 such that the upstream air-fuel ratio Afu becomes a target value. For example, depending on the operating status of the internal combustion engine 10, the CPU 72 operates the EGR valve 34 to perform open loop control over the flow rate of exhaust gas (EGR amount) flowing from the exhaust passage 28 to the intake passage 12 via the EGR passage 32. The ROM 74 stores a misfire detection program 74a and a re-training sub-program 74b. The re-training sub-program 74b is a program for re-training the evaluation map data 76b.

The communication instrument 77 is a device for communicating with a data analysis center 120 via a network 110 outside the vehicle VC1. The data analysis center 120 analyzes data that is sent from a plurality of vehicles VC1, VC2, . . . . The data analysis center 120 includes a CPU 122, a ROM 124, a memory 126, a communication instrument 127, and a peripheral circuit 128, which are communicable through a local network 129. The ROM 124 stores a re-training main program 124a that defines a process of re-training the evaluation map data 76b based on data sent from the vehicles VC1, VC2, . . . . The memory 126 stores re-training data 126a that is data sent from the vehicles VC1, VC2, . . . for re-training a map defined by the evaluation map data 76b.

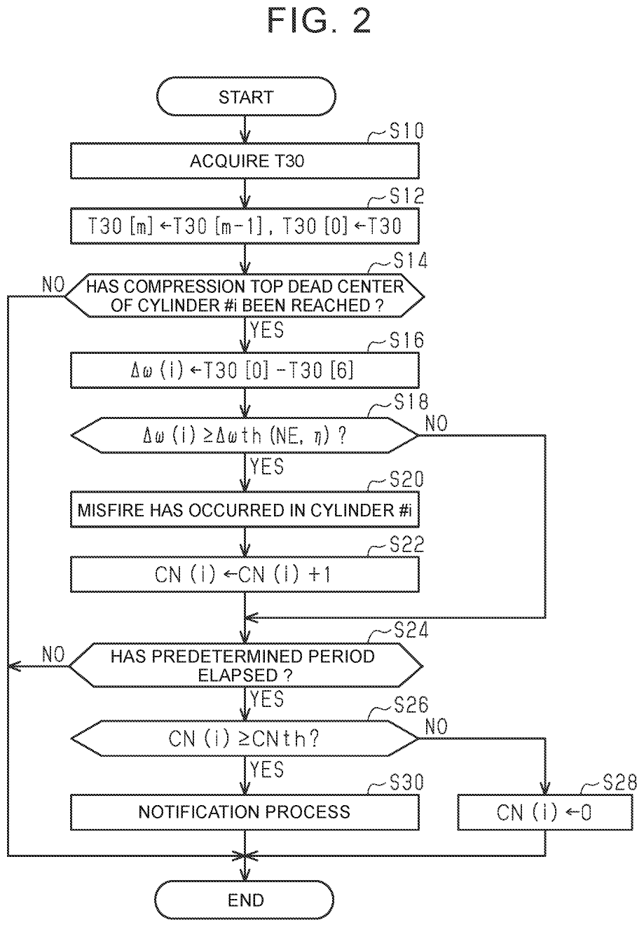

FIG. 2 shows part of a process that is implemented by the CPU 72 running the misfire detection program 74a stored in the ROM 74. The process shown in FIG. 2 is a process using the service map data 76a. The process shown in FIG. 2 is, for example, repeatedly executed at a predetermined period. Hereinafter, numerals prefixed with “S” represent step numbers of each process.

In a series of step shown in FIG. 2, the CPU 72 initially acquires a minute rotation time T30 (S10). A minute rotation time T30 is a time required for the crankshaft 24 to rotate 30° CA and is calculated by the CPU 72 based on an output signal Scr of the crank angle sensor 80. Subsequently, the CPU 72 sets the latest minute rotation time T30 acquired in S10 as the minute rotation time T30[0] and sets a variable “m” of a minute rotation time T30[m] to a greater value for the older minute rotation time T30 (S12). In other words, where m=1, 2, 3, . . . , the minute rotation time T30[m−1] just before S12 is executed is set to the minute rotation time T30[m]. Thus, for example, the minute rotation time T30 acquired in S10 when the process of FIG. 2 executed last time is the minute rotation time T30[1]. Of the minute rotation times T30[0], T30[1], T30[2], . . . , any adjacent minute rotation times T30 in time series respectively indicate times required to rotate adjacent angular intervals of 30° CA, and any adjacent angular intervals do not have an overlapped portion.

Subsequently, the CPU 72 determines whether the minute rotation time T30 acquired in S10 is a time required to rotate an angular interval from a point 30° CA before the compression top dead center to the compression top dead center in any one of the cylinders #1, #2, #3, #4 (S14). When the CPU 72 determines that the minute rotation time T30 is a time required to rotate the angular interval to the compression top dead center (YES in S14), the CPU 72 substitutes “T30[0]-T30[6]” into a rotation variation Δω(i) of the target cylinder #i to determine the presence or absence of misfire in the cylinder reaching the compression top dead center (S16). In other words, a rotation variation Δω is quantified by subtracting a time required to rotate an angular interval from a point 30° CA before the compression top dead center to the compression top dead center of the cylinder that reaches the compression top dead center previously to the target cylinder for determination as to a misfire from a time required to rotate an angular interval from a point 30° CA before the compression top dead center to the compression top dead center of the target cylinder.

Subsequently, the CPU 72 determines whether the rotation variation Δω(i) is greater than or equal to a prescribed amount Δωth (S18). This step is a step of determining whether a misfire has occurred in the target cylinder. The CPU 72 variably sets the prescribed amount Δωth based on a rotation speed NE and a charging efficiency η that define an operating point of the internal combustion engine 10.

More specifically, in a state where map data that uses the rotation speed NE and the charging efficiency η as input variables and uses the prescribed amount Δωth as an output variable is prestored in the memory 76, the prescribed amount Δωth is obtained through map computation of the CPU 72. Map data is dataset of discrete values of input variables and values of output variables respectively associated with the values of the input variables. In map computation, for example, when the value of an input variable coincides with any one of the values of the input variables of the map data, the associated value of the output variable of the map data may be used as a computed result; whereas, when the value of an input variable does not coincide with any one of the values of the input variables, a value obtained through interpolation using a plurality of the values of the output variables included in the map data may be used as a computed result.

A rotation speed NE is calculated by the CPU 72 based on the output signal Scr of the crank angle sensor 80. A rotation speed NE is an average of rotation speed when the crankshaft 24 rotates an angular interval greater than the interval of appearance of the compression top dead center (in the present embodiment, 180° CA). A rotation speed NE is desirably an average of rotation speed when the crankshaft 24 rotates a rotation angle greater than or equal to one revolution of the crankshaft 24. An average is not limited to a simple average and may be, for example, obtained as an exponential moving average. In short, a low-frequency component obtained by excluding higher-order components that fluctuate in about the interval of appearance of the compression top dead center may be calculated as an average. A charging efficiency η is calculated by the CPU 72 based on a rotation speed NE and an intake air volume Ga.

In S16 and S18, the service map data 76a is used. In other words, the service map data 76a defines a map that uses the minute rotation time T30[0] and the minute rotation time T30[6] as inputs and outputs a logical value indicating whether a misfire has occurred in the target cylinder as an output value. The logical value is a value on whether the proposition that the rotation variation Δω(i) is greater than or equal to the prescribed amount Δωth is true or false.

When the CPU 72 determines that the rotation variation Δω(i) is greater than or equal to the prescribed amount Δωth (YES in S18), the CPU 72 determines that a misfire has occurred in the cylinder #i (S20). Subsequently, the CPU 72 increments a misfire counter CN(i) of the cylinder #i (S22). After that, the CPU 72 determines whether the logical OR of a lapse of a predetermined period from when S18 is executed for the first time in a state where the misfire counter CN(i) is initialized and a lapse of a predetermined period from when S28 (described later) is executed (S24). When the CPU 72 determines that the logical OR is true (YES in S24), the CPU 72 determines whether the misfire counter CN(i) is greater than or equal to a threshold CNth (S26). When the CPU 72 determines that the misfire counter CN(i) is less than the threshold CNth (NO in S26), the CPU 72 initializes the misfire counter CN(i) (S28).

In contrast to this, when the CPU 72 determines that the misfire counter CN(i) is greater than or equal to the threshold CNth (YES in S26), the CPU 72 notifies a user of occurrence of an abnormality by operating an alarm lamp 104 shown in FIG. 1 (S30).

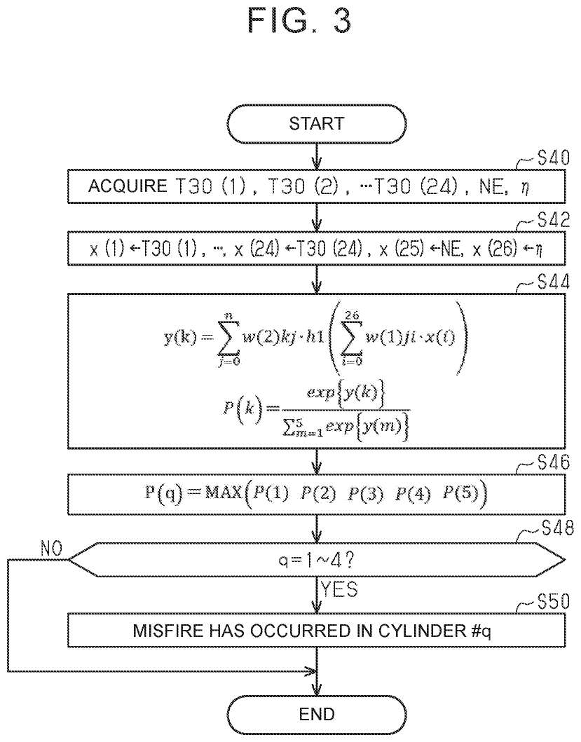

When the CPU 72 completes S28 or S30 or when the CPU 72 makes negative determination in S14 or S24, the CPU 72 once ends the series of steps shown in FIG. 2. FIG. 3 shows the procedure of part of the process that is implemented by the CPU 72 running the misfire detection program 74a stored in the ROM 74. The process shown in FIG. 3 is a process using the evaluation map data 76b.

In a series of steps shown in FIG. 3, the CPU 72 initially acquires minute rotation times T30(1), T30(2), T30(3), T30(4), T30(5), T30(6), T30(7), T30(8), T30(9), T30(10), T30(11), T30(12), T30(13), T30(14), T30(15), T30(16), T30(17), T30(18), T30(19), T30(20), T30(21), T30(22), T30(23), T30(24), a rotation speed NE, and a charging efficiency η (S40). The minute rotation times T30(1), T30(2), . . . are different from the minute rotation times T30[1], T30[2], . . . of FIG. 2. Particularly, among the minute rotation times T30(1), T30(2), . . . , the minute rotation time T30 is a later value as the numeral in the parentheses increases. The minute rotation times T30(1), T30(2), T30(3), T30(4), T30(5), T30(6), T30(7), T30(8), T30(9), T30(10), T30(11), T30(12), T30(13), T30(14), T30(15), T30(16), T30(17), T30(18), T30(19), T30(20), T30(21), T30(22), T30(23), T30(24) are respectively rotation times in 24 angular intervals obtained by equally dividing a rotation angle range of 720° CA by 30° CA.

Subsequently, the CPU 72 substitutes the values acquired in S40 into the input variables x(1), x(2), x(3), x(4), x(5), x(6), x(7), x(8), x(9), x(10), x(11), x(12), x(13), x(14), x(15), x(16), x(17), x(18), x(19), x(20), x(21), x(22), x(23), x(24), x(25), x(26) of the map defined by the evaluation map data 76b (S42). More specifically, the CPU 72 substitutes the minute rotation times T30(s) into the input variables x(s) where s=1 to 24. In other words, the input variables x(1), x(2), x(3), x(4), x(5), x(6), x(7), x(8), x(9), x(10), x(11), x(12), x(13), x(14), x(15), x(16), x(17), x(18), x(19), x(20), x(21), x(22), x(23), x(24) are time-series data of the minute rotation time T30. The CPU 72 substitutes the rotation speed NE into the input variable x(25) and substitutes the charging efficiency Y into the input variable x(26).

Subsequently, the CPU 72 calculates misfire variables P(1), P(2), P(3), P(4), P(5) by inputting input variables x(1), x(2), x(3), x(4), x(5), x(6), x(7), x(8), x(9), x(10), x(11), x(12), x(13), x(14), x(15), x(16), x(17), x(18), x(19), x(20), x(21), x(22), x(23), x(24), x(25), x(26) to the map defined by the evaluation map data 76b (S44). Where i=1 to 4, the misfire variable P(i) is a variable that takes on a greater value in the case of a high probability that a misfire has occurred in the cylinder #i than in the case of a low probability. The misfire variable P(5) is a variable that takes on a greater value in the case of a high probability that no misfire has occurred in any of the cylinders #1, #2, #3, #4 than in the case of a low probability.

More specifically, the map defined by the evaluation map data 76b is a neural network having a single intermediate layer. The neural network contains coefficients w(1)ji (j=0 to n, i=0 to 26) and an activation function hl(x). The activation function hl(x) serves as a nonlinear map that nonlinearly transforms outputs of a linear map defined by the coefficients w(1)ji. In the present embodiment, a hyperbolic tangent is illustrated as the activation function hl(x). w(1)j0, and the like, are bias parameters, and the input variable x(0) is defined as “1”.

The neural network contains coefficients w(2)kj (k=1 to 5, j=0 to n) and a softmax function. The softmax function uses original variable y(1), y(2), y(3), y(4), y(5) as inputs and outputs the misfire variables P(1), P(2), P(3), P(4), P(5). The original variable y(1), y(2), y(3), y(4), y(5) are outputs of a linear map defined by coefficients w(2)kj.

Subsequently, the CPU 72 identifies the maximum one of the misfire variables P(1), P(2), P(3), P(4), P(5) (S46). Then, the CPU 72 determines whether the maximum misfire variable P(q) is any one of the misfire variables P(1), P(2), P(3), P(4) or the misfire variable P(5) (S48). When the CPU 72 determines that the maximum misfire variable P(q) is any one of the misfire variables P(1), P(2), P(3), P(4) (YES in S48), the CPU 72 determines that a misfire has occurred in the cylinder #q (S50).

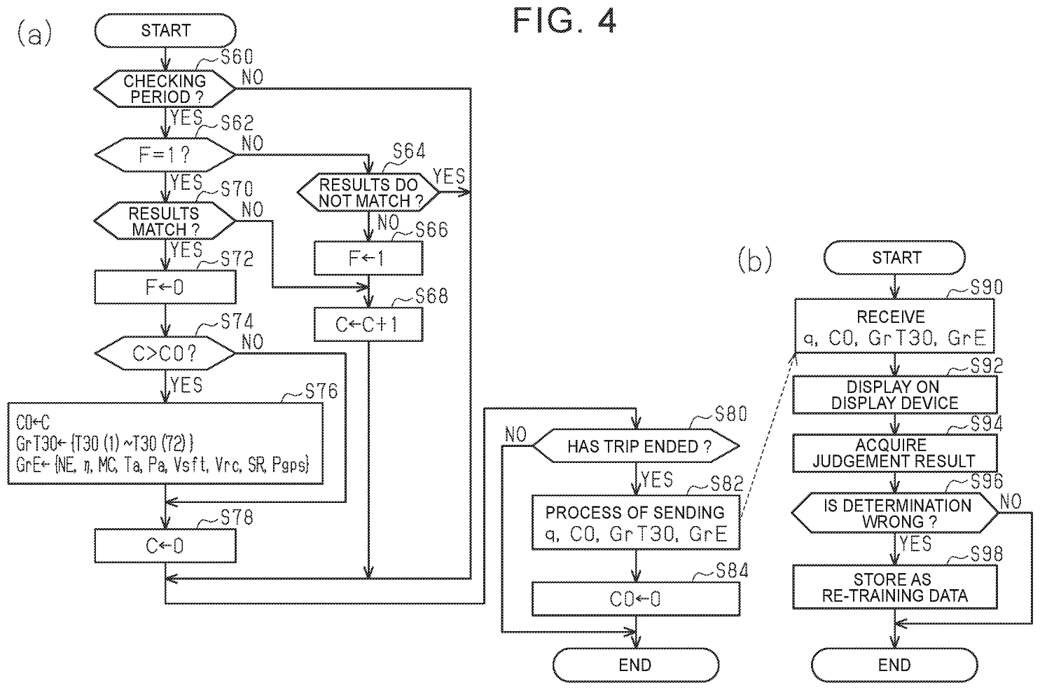

When the CPU 72 completes S50 or when the CPU 72 makes negative determination in S48, the CPU 72 once ends the series of steps shown in FIG. 3. FIG. 4 shows the procedure of part of a process on re-training of the evaluation map data 76b according to the present embodiment. The process shown in (a) of FIG. 4 is implemented by the CPU 72 running the re-training sub-program 74b stored in the ROM 74 shown in FIG. 1. The process shown in (b) of FIG. 4 is implemented by the CPU 122 running the re-training main program 124a stored in the ROM 124.

In a series of steps shown in (a) of FIG. 4, the CPU 72 initially determines whether it is in a checking period during which the reliability of the evaluation map data 76b is checked (S60). specifically, in the present embodiment, the checking period includes the following periods.

(I) Period During which Coolant Temperature THW is Lower than Predetermined Temperature

When the coolant temperature THW is low, combustion easily becomes unstable, and it is difficult to improve the accuracy of misfire detection as compared to when the coolant temperature THW is high. Therefore, this period is included in the checking period.

(II) Period During which Intake Air Temperature Ta is Lower than or Equal to Prescribed Temperature

When the intake air temperature Ta is low, combustion easily becomes unstable, and it is difficult to improve the accuracy of misfire detection as compared to when the intake air temperature Ta is high. Therefore, this period is included in the checking period.

(III) Period During which Process of Warming Up Catalyst 30 is being Executed

During a period in which the process of warming up the catalyst 30 is being executed, combustion is performed at a low combustion efficiency, so combustion easily becomes unstable, and it is difficult to improve the accuracy of misfire detection as compared to after warm-up of the catalyst 30. Therefore, this period is included in the checking period.

(IV) Period During which Charging Efficiency η is Lower than or Equal to Predetermined Value

Under a light load, combustion easily becomes unstable as compared to under a high load, and it is difficult to improve the accuracy of misfire detection as compared to under an intermediate or high load. Therefore, this period is included in the checking period.

(V) Period During which Among of Change ΔNE Per Predetermined Time in Rotation Speed NE is Greater than or Equal to Predetermined Value

During transitional operation, the accuracy of misfire detection easily decreases as compared to during steady operation. Therefore, this period is included in the checking period.

When the CPU 72 determines that it is in the checking period (YES in S60), the CPU 72 determines whether a flag F is “1” (S62). The flag F is set to “1” when the misfire determination result made through the process of FIG. 2 and the misfire determination result made through the process shown in FIG. 3 do not match; whereas, the flag F is set to “0” when both the misfire determination results match. When the CPU 72 determines that the flag F is “0” (NO in S62), the CPU 72 determines whether the misfire determination result made through the process shown in FIG. 2 and the misfire determination result made through the process shown in FIG. 3 do not match (S64). The CPU 72 determines that both the determination results do not match when the four-time determination results made in S18 of FIG. 2 in the same combustion cycle and the determination result made in S46 of FIG. 3 do not match. In other words, the CPU 72 determines that both the determination results do not match, for example, when the CPU 72 selects P(5) in S46 although the CPU 72 determines in S18 that the rotation variation Δω(1) of the cylinder #1 is greater than or equal to the prescribed amount Δωth.

When the CPU 72 determines that both the determination results do not match (NO in S64), the CPU 72 substitutes “1” into the flag F (S66). After that, the CPU 72 increments the counter C (S68). In contrast to this, when the CPU 72 determines that the flag F is “1” (YES in S62), the CPU 72 determines whether the misfire determination result made through the process shown in FIG. 2 and the misfire determination result made through the process shown in FIG. 3 match (S70). When the CPU 72 determines that both the determination results do not match (NO in S70), the CPU 72 proceeds to S68; whereas, when the CPU 72 determines that both the determination result match (YES in S70), the CPU 72 substitutes “0” into the flag F (S72). The CPU 72 determines whether the counter C is greater than a maximum value CO (S74). When the CPU 72 determines that the counter C is greater than the maximum value CO (YES in S74), the CPU 72 updates the maximum value CO with the value of the current counter C and updates a rotation time group GrT30 and an extra information group GrE (S76).

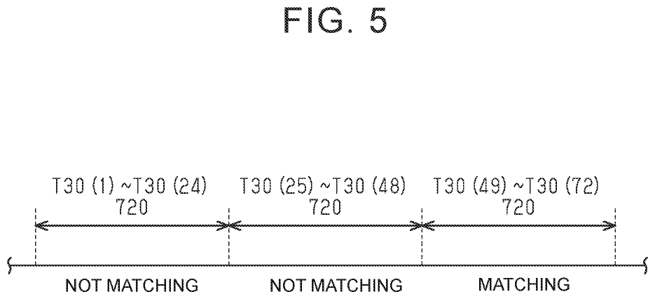

More specifically, the rotation time group GrT30 is a group of the minute rotation times T30(1), T30(2), T30(3), T30(4), T30(5), T30(6), T30(7), T30(8), T30(9), T30(10), T30(11), T30(12), T30(13), T30(14), T30(15), T30(16), T30(17), T30(18), T30(19), T30(20), T30(21), T30(22), T30(23), T30(24), T30(25), T30(26), T30(27), T30(28), T30(29), T30(30), T30(31), T30(32), T30(33), T30(34), T30(35), T30(36), T30(37), T30(38), T30(39), T30(40), T30(41), T30(42), T30(43), T30(44), T30(45), T30(46), T30(47), T30(48), T30(49), T30(50), T30(51), T30(52), T30(53), T30(54), T30(55), T30(56), T30(57), T30(58), T30(59), T30(60), T30(61), T30(62), T30(63), T30(64), T30(65), T30(66), T30(67), T30(68), T30(69), T30(70), T30(71), T30(72) for three combustion cycles, as shown in FIG. 5. However, the set of minute rotation times T30(49), T30(50), T30(51), T30(52), T30(53), T30(54), T30(55), T30(56), T30(57), T30(58), T30(59), T30(60), T30(61), T30(62), T30(63), T30(64), T30(65), T30(66), T30(67), T30(68), T30(69), T30(70), T30(71), T30(72) is updated so as to be associated with the combustion cycle in which the CPU 72 determines in the latest S70 that the misfire determination result made through the process shown in FIG. 2 and the misfire determination process made through the process shown in FIG. 3 match. When the maximum value CO is greater than or equal to “2”, both the sets of the minute rotation times T30(1), T30(2), T30(3), T30(4), T30(5), T30(6), T30(7), T30(8), T30(9), T30(10), T30(11), T30(12), T30(13), T30(14), T30(15), T30(16), T30(17), T30(18), T30(19), T30(20), T30(21), T30(22), T30(23), T30(24) and the minute rotation times T30(25), T30(26), T30(27), T30(28), T30(29), T30(30), T30(31), T30(32), T30(33), T30(34), T30(35), T30(36), T30(37), T30(38), T30(39), T30(40), T30(41), T30(42), T30(43), T30(44), T30(45), T30(46), T30(47), T30(48) are associated with the combustion cycle in which the misfire determination result made through the process of FIG. 2 and the misfire determination result made through the process shown in FIG. 3 do not match. The initial value of the maximum value CO is zero.

The extra information group GrE includes the rotation speed NE, the charging efficiency q, a combustion control mode value MC, the intake air temperature Ta, the atmospheric pressure Pa, the shift position Vsft of the transmission 54, an engagement status value Vrc, the value of a variable indicating the condition of a road surface on which the vehicle VC1 is traveling (road surface condition value SR), and the value of a position variable (position data Pgps) that is a variable indicating the position of the vehicle VC1. The engagement status value Vrc is a logical value of a variable indicating the engagement status of the lockup clutch 52. The engagement status value Vrc is “1” when the lockup clutch 52 is engaged; otherwise, the engagement status value Vrc is “0”. The road surface condition value SR is “1” when the irregularities of a road surface on which the vehicle VC1 travels is remarkable; otherwise the road surface condition value SR is “0”. The road surface condition value SR may be set to “1” when an average of the absolute value of the acceleration Gy during a predetermined period is higher than or equal to a predetermined value. The pieces of data that make up the extra information group GrE are desirably values in the combustion cycle before the combustion cycle in which the CPU 72 makes affirmative determination in S70.

Referring back to FIG. 4, when the CPU 72 completes S76 or when the CPU 72 makes negative determination in S74, the CPU 72 initializes the counter C (S78). When the CPU 72 completes S68 or S78 or when the CPU 72 makes negative determination in S60 or when the CPU 72 makes affirmative determination in S64, the CPU 72 determines whether it is the time to end a trip (S80). A trip is a single period during which a travel permission signal for a vehicle is in an on state. In the present embodiment, a travel permission signal corresponds to an ignition signal. When the CPU 72 determines that it is the time to end the trip (YES in S80), the CPU 72 sends the information “q” on the maximum one of the misfire variables P(1), P(2), P(3), P(4), P(5), the maximum value CO, the rotation time group GrT30, and the extra information group GrE to the data analysis center 120 by operating the communication instrument 77 (S82). Then, the CPU 72 initializes the maximum value CO (S84) and once ends the series of steps shown in (a) of FIG. 4. When the CPU 72 makes negative determination in S80 as well, the CPU 72 once ends the series of steps shown in (a) of FIG. 4.

In contrast to this, as shown in (b) of FIG. 4, the CPU 122 receives the information “q” about the maximum one of the misfire variables P(1), P(2), P(3), P(4), P(5), the maximum value CO, the rotation time group GrT30, and the extra information group GrE (S90). Then, the CPU 122 displays waveform data on the rotation behavior of the crankshaft 24, expressed by the rotation time group GrT30, and also displays the maximum value CO and the extra information group GrE on a display device 112 shown in FIG. 1 (S92). This is a step of providing an expert with information that the expert is able to judge whether a misfire has occurred. In other words, an expert is able to highly accurately judge whether a misfire has occurred by seeing the waveform data. At this time, by referencing information of the extra information group GrE, judgement as to whether a misfire has occurred becomes further reliable. Thus, an expert is able to judge whether misfire determination using the evaluation map data 76b is wrong based on judgement as to whether a misfire has occurred.

When an expert inputs a judgement result by operating an interface 114 shown in FIG. 1, the CPU 122 acquires the judgement result (S94). Then, the CPU 122 determines whether the judgement result input by operating the interface 114 is a judgement that misfire determination using the evaluation map data 76b is wrong (S96). When the CPU 122 determines that the judgement result indicates that misfire determination using the evaluation map data 76b is wrong (YES in S96), the CPU 122 stores the minute rotation times T30(25), T30(26), T30(27), T30(28), T30(29), T30(30), T30(31), T30(32), T30(33), T30(34), T30(35), T30(36), T30(37), T30(38), T30(39), T30(40), T30(41), T30(42), T30(43), T30(44), T30(45), T30(46), T30(47), T30(48), the extra information group GrE, and the judgement result made by the expert as to whether a misfire has occurred, of the data received in S90, as the re-training data 126a (S98). The re-training data 126a includes data based on data received from not only the vehicle VC1 but also the other vehicles VC2, . . . on which an internal combustion engine having the same specifications as the internal combustion engine 10 is mounted.

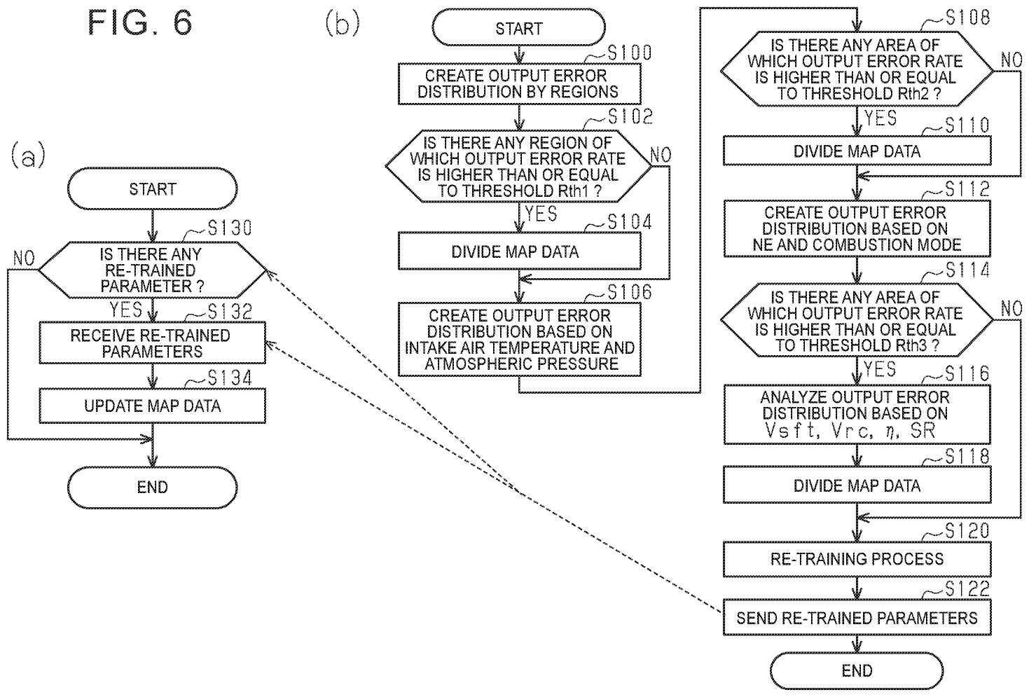

When the CPU 122 makes negative determination in S96 or when the CPU 122 completes S98, the CPU 122 once ends a series of steps shown in (b) of FIG. 4. Through the above process, input data in the case where the evaluation map data 76b provides a wrong determination and data related to the input data are accumulated in the memory 126 as the re-training data 126a. After that, when the re-training data 126a becomes larger than or equal to a predetermined amount, the CPU 122 executes a process shown in FIG. 6.

FIG. 6 shows the procedure of part of the process on re-training of the evaluation map data 76b according to the present embodiment. The process shown in (a) of FIG. 6 is implemented by the CPU 72 running the re-training sub-program 74b stored in the ROM 74 shown in FIG. 1. The process shown in (b) of FIG. 6 is implemented by the CPU 122 running the re-training main program 124a stored in the ROM 124. Hereinafter, the process shown in FIG. 6 will be described in accordance with time series of the process on re-training of the evaluation map data 76b.

In a series of steps shown in (b) of FIG. 6, the CPU 122 initially classifies the re-training data 126a by regions in which associated vehicles are located at the time of sending data, and measures the number of data based on which the map defined by the evaluation map data 76b outputs an error for each of the classified regions, thus creating regional output error distribution data (S100). Data based on which an error is output is data determined to be wrong in S96. In the present embodiment, a divided region is defined as a country or a region smaller than a country. For example, when the land area is less than or equal to a predetermined area, a country, such as Korea and Taiwan, is used as a divided region. In contrast to this, in the case of China, or the like, having a large land area, for example, a province dividing a country, such as Tibet Autonomous Region and Sichuan province, is used as a divided region.

This step is to check whether the accuracy of determining a misfire varies depending on a difference in situation in which the vehicle VC is located for each region. In other words, it is checked whether the accuracy of the determination process using the evaluation map data 76b in a specific region becomes lower than the other region, for example, depending on regionality of properties of fuel that is supplied to the internal combustion engine 10 or any unexpected regionality.

The CPU 122 determines whether there is any region of which the output error rate is higher than or equal to a threshold Rth1 of the regions divided in S100 (S102). When the CPU 122 determines that there is an area of which the output error rate is higher than or equal to the threshold Rth1 (YES in S102), the CPU 122 divides the region in which the evaluation map data 76b is used into a region of which the output error rate is higher than or equal to the threshold Rth1 and the other regions (S104). In other words, the CPU 122 determines to separately update the evaluation map data 76b that is used in the region of which the output error rate is higher than or equal to the threshold Rth1 and the evaluation map data 76b that is used in the other regions.

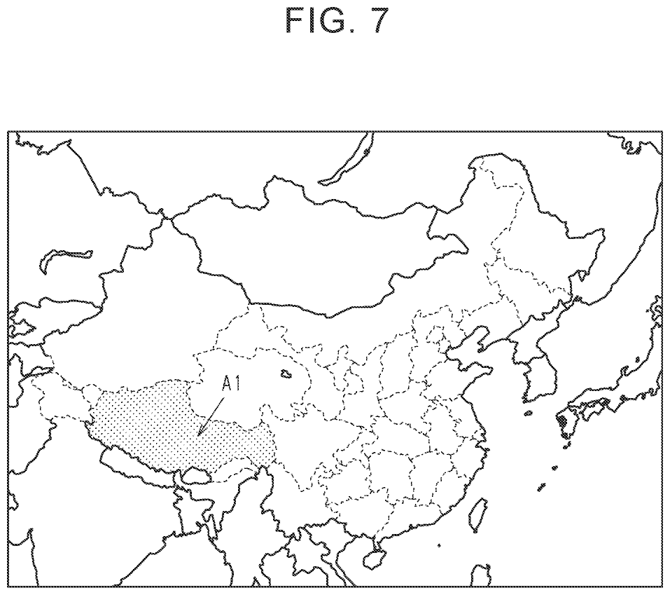

FIG. 7 illustrates that the output error rate is higher than or equal to the threshold Rth1 in an area A1. In this case, the CPU 122 determines to generate the area A1-specific evaluation map data 76b that is used in the area A1 and that is not used in areas other than the area A1.

Referring back to FIG. 6, when the CPU 122 completes S104 or when the CPU 122 makes negative determination in S102, the CPU 122 classifies the data that makes up the re-training data 126a by areas partitioned based on the intake air temperature Ta and the atmospheric pressure Pa, and measures the number of data based on which an error is output for each classified area, thus creating output error distribution data (S106). When the CPU 122 has already executed S104, the CPU 122 creates output error distribution data in areas partitioned based on the intake air temperature Ta and the atmospheric pressure Pa in each of the area of which the output error rate is determined to be higher than or equal to the threshold Rth1 in S102 and the other regions separately.

This step is to check whether the accuracy of determining a misfire varies depending on a difference in intake air temperature Ta or atmospheric pressure Pa. In other words, when the intake air temperature Ta is low, combustion of the internal combustion engine 10 easily becomes unstable as compared to when the intake air temperature Ta is high. Therefore, it is checked whether the accuracy of misfire detection decreases. When the atmospheric pressure Pa varies, the pressure in the exhaust passage 28 varies. Therefore, even when the opening degree of the EGR valve 34 is the same, the flow rate of exhaust gas flowing from the exhaust passage 28 to the intake passage 12 via the EGR passage 32 varies. For this reason, as in the case of the present embodiment, when the EGR valve 34 is operated to perform open loop control over the flow rate of exhaust gas flowing from the exhaust passage 28 to the intake passage 12 via the EGR passage 32, the flow rate of exhaust gas flowing from the exhaust passage 28 to the intake passage 12 via the EGR passage 32 varies according to the atmospheric pressure Pa, so the combustion state varies. It is checked whether the accuracy of misfire detection decreases depending on the combustion state.

The CPU 122 determines whether there is any area of which the output error rate is higher than or equal to a threshold Rth2 of the areas divided based on the intake air temperature Ta and the atmospheric pressure Pa (S108). When the CPU 122 determines that there is an area of which the output error rate is higher than or equal to the threshold Rth2 (YES in S108), the CPU 122 divides the area in which the evaluation map data 76b is used into an area of which the output error rate is higher than or equal to the threshold Rth2 and the other areas (S110). In other words, the CPU 122 determines to separately update the evaluation map data 76b that is used in the area of which the output error rate is higher than or equal to the threshold Rth2 and the evaluation map data 76b that is used in the other areas.

For example, as shown in FIG. 8, the CPU 122 determines to update the evaluation map data 76b for an area A2 separately from the other areas of the areas divided based on the intake air temperature Ta and the atmospheric pressure Pa. In the region in which the CPU 122 makes affirmative determination in S102, when there is an area in which the CPU 122 makes affirmative determination in S108, the CPU 122 may determine to separately update the evaluation map data 76b for each of the area in which the CPU 122 makes affirmative determination in S108 and the other areas in the region in which the CPU 122 makes affirmative determination in S102 and for the regions other than the region in which the CPU 122 makes affirmative determination in S102. Thus, for example, the area A1-specific evaluation map data 76b illustrated in FIG. 7 is divided into area A2-specific data illustrated in FIG. 8 and data specific to the areas other than the area A2.

Referring back to FIG. 6, when the CPU 122 completes S110 or when the CPU 122 makes negative determination in S108, the CPU 122 classifies the data that makes up the re-training data 126a by areas partitioned based on the rotation speed NE and the combustion control mode, and measures the number of data based on which an error is output for each classified area, thus creating output error distribution data (S112). The CPU 122 determines whether there is any area of which the output error rate is higher than or equal to a threshold Rth3 of the areas divided based on the rotation speed NE and the combustion control mode (S114).

This step is to check whether the accuracy of determining a misfire varies depending on the rotation speed NE or the combustion control mode. In other words, for example, in a control mode for warming up the catalyst 30, control for increasing the exhaust gas temperature by decreasing the combustion efficiency, so it is checked whether the accuracy of determining a misfire decreases because combustion easily becomes unstable as compared to when such control is not executed. For example, when the rotation speed NE is low, rotation easily becomes unstable because of small inertial energy of the crankshaft 24, and various operating parts are operated based on the rotation speed NE and the charging efficiency q, so it is checked whether the accuracy of determining a misfire decreases according to the rotation speed NE.

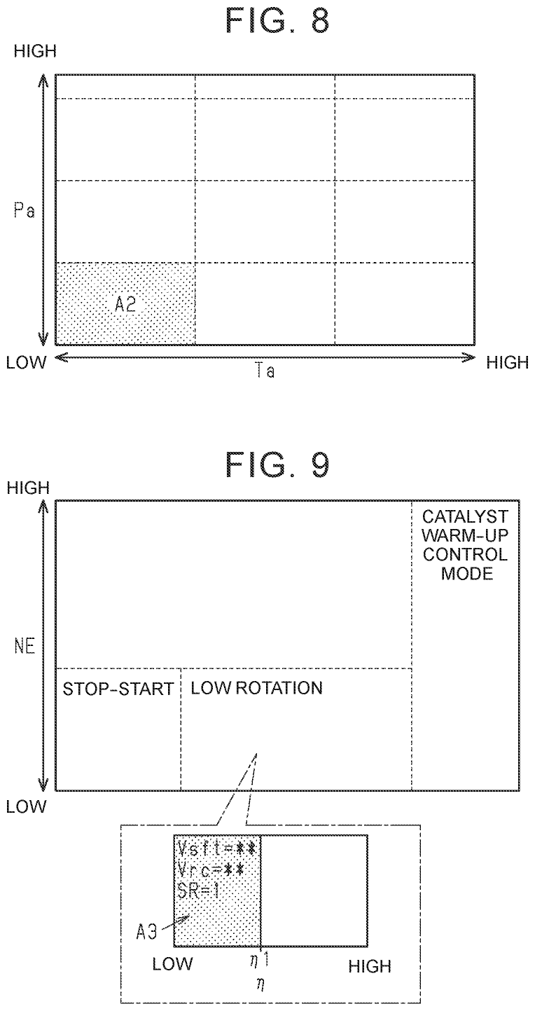

FIG. 9 illustrates areas divided based on the rotation speed NE and the combustion control mode in the present embodiment. In the present embodiment, areas are divided based on the combustion control mode value MC into areas of stop-start operation mode, the control mode for warming up the catalyst 30, and the other modes, and the area of the other modes is divided into a low rotation area and the other area.

When the CPU 122 has already executed S104, the CPU 122 creates output error distribution data separately in the region of which the output error rate is determined to be higher than or equal to the threshold Rth1 in S102 and the other regions. When the CPU 122 has already executed S110, the CPU 122 creates output error distribution data separately in the area of which the output error rate is determined to be higher than or equal to the threshold Rth2 in S108 and the other areas.

Referring back to FIG. 6, when the CPU 122 determines that there is an area of which the output error rate is higher than or equal to the threshold Rth3 of the areas shown in FIG. 9 (YES in S114), the CPU 122 analyzes the output error distribution for each of the shift position Vsft, the engagement status value Vrc, the charging efficiency q, and the road surface condition value SR in the area of which the output error rate is higher than or equal to the threshold Rth3 (S116).

This step is to check whether the accuracy of misfire detection varies according to the speed ratio of the transmission 54, the engagement status of the lockup clutch 52, the charging efficiency r, or the presence or absence of irregularities of a road surface on which the vehicle VC1 travels. In other words, the moment of inertia from the crankshaft 24 to the output shaft 58 of the transmission 54 varies according to the speed ratio of the transmission 54 or the engagement status of the lockup clutch 52, so the rotation behavior of the crankshaft 24 varies, and it is checked whether the accuracy of determining a misfire decreases at a predetermined moment of inertia. The rotation behavior of the crankshaft 24 varies depending on the irregularities of a road surface, so it is checked whether the accuracy of determining a misfire significantly decreases when the irregularities are remarkable as compared to when the vehicle travels on a flat road surface. When the charging efficiency η is small, the rotation behavior of the crankshaft 24 easily becomes unstable due to small combustion energy in the combustion chambers 18 as compared to when the charging efficiency η is large, so it is checked whether the accuracy of determining a misfire significantly decreases.

The CPU 122 divides the area in which the evaluation map data 76b is used into the area of which the output error rate is higher than or equal to the threshold Rth3 and the other areas (S118). Specifically, the CPU 122 determines to separately update the evaluation map data 76b that is used in the area of which the output error rate is higher than or equal to the threshold Rth3 and the evaluation map data 76b that is used in the other areas.

FIG. 9 illustrates that the output error rate exceeds the threshold Rth3 in the case of an area A3 in which the charging efficiency η is lower than or equal to a predetermined value qjl, the shift position Vsft is a predetermined position, the engagement status value Vrc is a predetermined value, and the road surface condition value SR is “1” in the low rotation area within the area that is neither the area of the stop-start operation mode nor the catalyst warm-p control mode. When the area A3 is present in the area A1 illustrated in FIG. 7, for example, the area A1-specific evaluation map data 76b may be divided into area A3-specific data and the other data. For example, when the area A3 is present in the area A2 illustrated in FIG. 8, for example, the area A2-specific evaluation map data 76b may be divided into area A3-specific data and the other data. Furthermore, for example, when the area A3 is present in the area A2 illustrated in FIG. 8 within the area A1 illustrated in FIG. 7, for example, specific evaluation map data 76b that belongs to both the area A1 and the area A2 may be divided into area A3-specific data and the other data.

Referring back to FIG. 6, when the CPU 122 completes S118 or when the CPU 122 makes negative determination in S114, the CPU 122 re-trains the evaluation map data 76b for each of the areas divided in S104, S110, and S118 (S120). In other words, for example, when the CPU 122 updates the evaluation map data 76b that is used in the area A1, the CPU 122 updates the evaluation map data 76b by using only the data of the re-training data 126a, sent in the area A1. For example, when the CPU 122 updates the evaluation map data 76b that is used when the area belongs to the area A1 and also belongs to the area A2, the CPU 122 updates the evaluation map data 76b by using only the data of the re-training data 126a, sent when the driving environment of vehicles located in the area A1. When the CPU 122 makes negative determination in each of S102, S108, and S114, the CPU 122 updates the evaluation map data 76b by using all the re-training data 126a.

Specifically, the CPU 72 updates the coefficients w(1)ji, w(2)kj that are the trained parameters of the evaluation map data 76b by selectively using the appropriate re-training data 126a as training data. In other words, the CPU 72 calculates the misfire variables P(l), P(2), P(3), P(4), P(5) y using the minute rotation times T30, the rotation speed NE, the charging efficiency η of the training data as the input variables x(1), x(2), x(3), x(4), x(5), x(6), x(7), x(8), x(9), x(10), x(11), x(12), x(13), x(14), x(15), x(16), x(17), x(18), x(19), x(20), x(21), x(22), x(23), x(24), x(25), x(26), and also generates teaching data on the judgement result as to whether a misfire has occurred, made by an expert. For example, when the expert judges that a misfire has occurred in the cylinder #1, the CPU 72 sets P(1) to 1 and sets P(2) to P(5) to 0. For example, when the expert judges that combustion is normal, the CPU 72 sets P(1) to P(4) to 0 and sets P(5) to 1. Then, the CPU 72 updates the coefficients w(1)ji, w(2)kj with a known technique such that the absolute value of the difference between the teaching data and the misfire variables P(1), P(2), P(3), P(4), P(5) output by the neural network reduces.

For the process of calculating the misfire variables P(1), P(2), P(3), P(4), P(5) in the data analysis center 120, information of the coefficients w(1)ji, w(2)kj, the activation function h, and information that the softmax function is used in the output layer of the neural network are required. In this regard, for example, the CPU 122 may output an instruction to send data on these pieces of information to the control apparatus 70 in advance of the process of (b) of FIG. 6 or, for example, these pieces of data may be prestored in the memory 126.

The CPU 122 sends the updated coefficients w(1)ji, w(2)kj as the re-trained parameters to the intended one(s) of the vehicles VC1, VC2, . . . by operating the communication instrument 127 (S122). In other words, for example, of the updated evaluation map data 76b, the area A1-specific coefficients w(1)ji, w(2)kj illustrated in FIG. 7 are selectively sent to the one(s) located in the area A1 of the vehicles VC, VC2, . . . . When the CPU 122 completes S122, the CPU 122 once ends the series of steps shown in (b) of FIG. 6.

On the other hand, as shown in (a) of FIG. 6, the CPU 72 determines whether there are re-trained parameters sent from the data analysis center 120 (S130). When the CPU 72 determines that there are re-trained parameters (YES in S130), the CPU 72 receives the coefficients w(1)ji, w(2)kj (S132) and updates the evaluation map data 76b stored in the memory 76 (S134).

When the CPU 72 completes S134 or when the CPU 72 makes negative determination in S130, the CPU 72 once ends a series of steps shown in (a) of FIG. 6. Here, the operation and advantageous effects of the present embodiment will be described.

The CPU 72 keeps a watch on the internal combustion engine 10 for a misfire by executing the process shown in FIG. 2 based on the service map data 76a and, when a misfire frequently occurs, executes the notification process to deal with this situation. The CPU 72 performs misfire determination using the evaluation map data 76b by executing the process shown in FIG. 3 based on the evaluation map data 76b. The CPU 72 determines whether the misfire determination result using the evaluation map data 76b and the misfire determination result using the service map data 76a match and, when both the misfire determination results do not match, sends the position data Pgps, the intake air temperature Ta, the atmospheric pressure Pa, and the like, to the data analysis center 120 in addition to input data for misfire determination using the evaluation map data 76b. This is a step because there are concerns that training of the evaluation map data 76b is not sufficient.

In contrast to this, the CPU 122 displays the input data, and the like, sent from the CPU 72 on the display device 112. Thus, an expert judges whether a misfire has occurred based on the waveform data, or the like, that represents the rotation behavior of the crankshaft 24 and, based on the judgement, judges whether the determination as to the presence or absence of misfire using the evaluation map data 76b is wrong. When the judgement result of the expert indicates that the determination as to the presence or absence of misfire using the evaluation map data 76b is wrong, the CPU 122 stores at least part of the data sent from the vehicle in the memory 126 as the re-training data 126a.

When the re-training data 126a becomes larger than or equal to the predetermined amount, the CPU 122 determines whether the accuracy of the determination process using the evaluation map data 76b is particularly low in a specific area of the areas partitioned based on the position data Pgps, the intake air temperature Ta, the atmospheric pressure Pa, and the like. When there is an area in which the accuracy of the determination process is particularly low, the CPU 122 generates specific evaluation map data 76b that is used when a vehicle enters the area by updating the evaluation map data 76b using only training data on that area. Thus, the accuracy of determining a misfire is improved without a complicated structure of the map defined by the evaluation map data 76b.

In other words, for example, when the accuracy of determining a misfire is particularly low in the area A1 illustrated in FIG. 7, it is conceivable that a situation peculiar to the area A1 is present as a situation that decreases the determination accuracy. In contrast to this, even when a large amount of re-training data 126a is merely accumulated and re-training is performed using all of the re-training data 126a, it is not always easy to improve the accuracy of determining a misfire without a complicated structure of the evaluation map data 76b. This is because, when the area A1 has a peculiar situation to decrease the accuracy of determining a misfire, optimal values of the coefficients w(1)ji, w(2)kj can vary between the area A1 and the other area. If the number of dimensions of inputs is increased by, for example, increasing the number of intermediate layers, further adding position data Pgps to the inputs to the map defined by the evaluation map data 76b, or the like, there is a possibility that the accuracy of determining a misfire can be increased in both the area A1 and the other areas. However, in this case, the structure of the map defined by the evaluation map data 76b is complicated, and computation load on the process of determining a misfire using the map increases. In contrast to this, in the present embodiment, when there is an area in which the accuracy of determining a misfire is low, specific evaluation map data 76b that is used in that area is generated. Thus, the accuracy of determining a misfire is improved without a complicated structure of the map defined by the evaluation map data 76b.

The CPU 122 sends the updated coefficients w(1)ji, w(2)kj as the re-trained data to the intended ones of the vehicles VC1, VC2, . . . For example, the CPU 122 sends the area A1-specific coefficients w(1)ji, w(2)kj to the vehicles located in the area A1. Thus, in the vehicles located in the area A1, the evaluation map data 76b is updated with the evaluation map data 76b of which the evaluation accuracy in the area A1 is improved.

After that, in judgement of the expert at the time when both the determination results do not match through the process of FIG. 4, when it is found that the evaluation map data 76b has a higher reliability than the service map data 76a, the updated evaluation map data 76b can be used as the service map data 76a to keep a watch for a misfire in the vehicles to which the updated coefficients w(1)ji, w(2)kj have been sent. Furthermore, a model (map data) trained by using raw data and installed in the vehicles VC1, VC2, . . . may be installed as service map data from the beginning in a control apparatus installed in a vehicle including a newly developed internal combustion engine with the same number of cylinders.

### Second Embodiment

Hereinafter, a second embodiment will be described with reference to the accompanying drawing with a focus on the difference from the first embodiment.

The service map data 76a and the evaluation map data 76b according to the present embodiment are data that defines a map that outputs a value of an imbalance variable Inb. The imbalance variable Inb is a variable indicating an imbalance that is variations among actual air-air-fuel ratios when the fuel injection valves 20 are operated to control the air-fuel ratios of air-fuel mixtures in the cylinders #1, #2, #3, #4 to an equal air-fuel ratio.

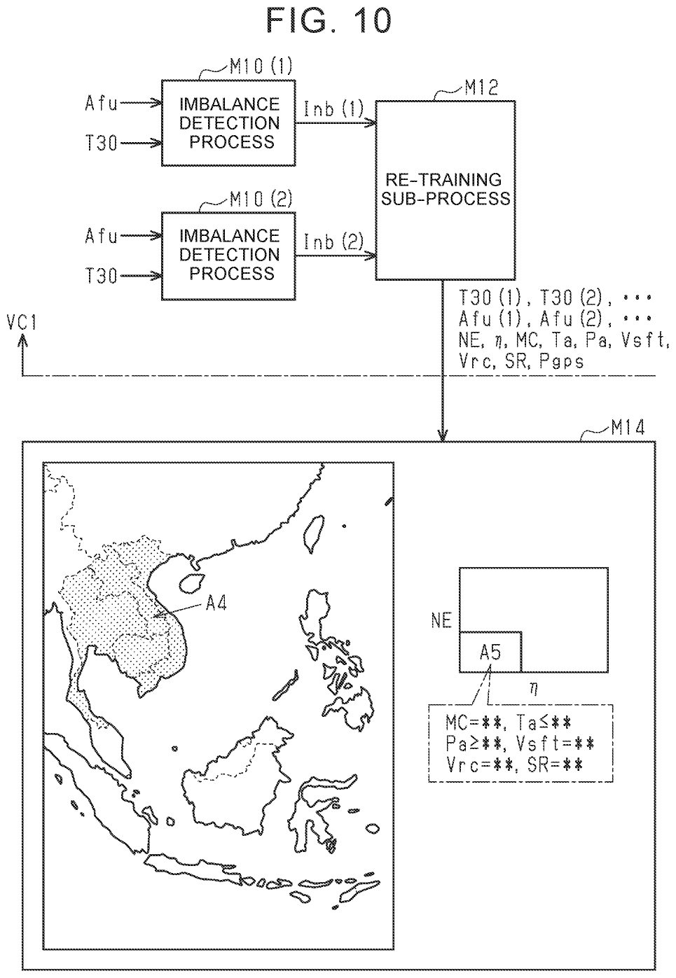

FIG. 10 shows a process that a learning system for a vehicle according to the present embodiment executes. The process shown in FIG. 10 includes a process that is implemented by the CPU 72 running a program stored in the ROM 74 and a process that is implemented by the CPU 122 running a program stored in the ROM 124.

An imbalance detection process M10(1) is a process of calculating the value of an imbalance variable Inb(1) by using the service map data 76a. The imbalance detection process M10(1) includes a process of calculating the value of the imbalance variable Inb(1) at the time when the imbalance variable Inb(1) indicates a rich-side value, based on the amount of change in upstream air-fuel ratio Afu per predetermined time. The imbalance detection process M10(1) also includes a process of calculating the value of the imbalance variable Inb(1) at the time when the imbalance variable Inb(1) indicates a lean-side value, based on a variation in minute rotation time T30.

An imbalance detection process M10(2) is a process of calculating the value of an imbalance variable Inb(2) by using the evaluation map data 76b. The imbalance detection process M10(2) is a process of calculating the value of the imbalance variable Inb(2) by using a neural network that uses time-series data made up of the minute rotation times T30(1), T30(2), T30(3), T30(4), T30(5), T30(6), T30(7), T30(8), T30(9), T30(10), T30(11), T30(12), T30(13), T30(14), T30(15), T30(16), T30(17), T30(18), T30(19), T30(20), T30(21), T30(22), T30(23), T30(24) and time-series data of the upstream air-fuel ratio Afu in that period as inputs and outputs the value of the imbalance variable Inb(2).

A re-training sub-process M12 includes a process of, when the absolute value of the difference between the imbalance variable Inb(1) and the imbalance variable Inb(2) is greater than or equal to a predetermined value, determining that the determination result using the service map data 76a and the determination result using the evaluation map data 76b do not match. The re-training sub-process M12 includes a process of sending predetermined data to the data analysis center 120. Data to be sent includes not only the minute rotation times T30 and the upstream air-fuel ratios Afu used to calculate the imbalance variable Inb(2) at the time when both the determination results do not match but also adjacent time-series data of the minute rotation time T30 and adjacent time-series data of the upstream air-fuel ratio Afu. This is for an expert to be able to accurately judge whether the imbalance variable Inb(2) is a correct value based on the rotation behavior of the crankshaft 24 or the behavior of the upstream air-fuel ratio Afu.

Data to be sent includes the rotation speed NE and the charging efficiency 9 as the values of operating point variables that are variables indicating the operating point of the of the internal combustion engine 10 at the time when both the determination results do not match. The values of the operating point variables are data for an expert to be able to further accurately judge whether the imbalance variable Inb(2) is a correct value and are data for checking whether the accuracy of the imbalance variable Inb(2) varies according to the operating point.

Date to be sent includes the combustion control mode value MC. In the present embodiment, a value for identifying a mode based on the value of a target air-fuel ratio or a mode to increase the exhaust gas temperature for the process of regenerating the catalyst 30 or the other modes is illustrated as the combustion control mode value MC. This takes into consideration a difference in the influence of variations in actual air-fuel ratio among the cylinders on the rotation behavior of the crankshaft 24 or the upstream air-fuel ratio Afu depending on a difference in combustion control mode. For this reason, the combustion control mode value MC is data for an expert to be able to further accurately judge whether the imbalance variable Inb(2) is a correct value and is data for checking whether the accuracy of the imbalance variable Inb(2) varies depending on the value.

Data to be sent includes the intake air temperature Ta, the atmospheric pressure Pa, the shift position Vsft, the engagement status value Vrc, the road surface condition value SR, and the position data Pgps. Significance of these pieces of data is similar to that of the above-described first embodiment.

The CPU 122 executes processes similar to FIG. 4 and FIG. 6 as a re-training process M14. The process similar to the process of FIG. 4 includes a process of, when the absolute value of the difference between a value that is appropriate as the value of the imbalance variable Inb in the data analysis center 120 and the output value of the map defined by the evaluation map data 76b is greater than or equal to a predetermined value, determining that the output is an error. In the present embodiment, an example in which, subsequently to evaluation of the output error rate by regions, evaluation of the output error rate by areas partitioned based on the operating point variables is performed will be described. FIG. 10 illustrates a case where the output error rate is particularly high when the output error rate in vehicles located in an area A4 is higher than or equal to a threshold because of a difference in output error rate based on the position data Pgps and, within the area A4, an area partitioned based on the operating point variables falls within the area A5. More specifically, FIG. 10 shows an example in which, in an area A5, the output error rate is particularly high in a predetermined area partitioned based on the combustion control mode value MC, the intake air temperature Ta, the atmospheric pressure Pa, the shift position Vsft, the engagement status value Vrc, and the road surface condition value SR. Therefore, the CPU 122 updates area A4-specific evaluation map data 76b with different pieces of data based on whether a vehicle is located in the area A5 and the predetermined area or located in the other areas.

### Third Embodiment

Hereinafter, a third embodiment will be described with reference to the accompanying drawing with a focus on the difference from the first embodiment.

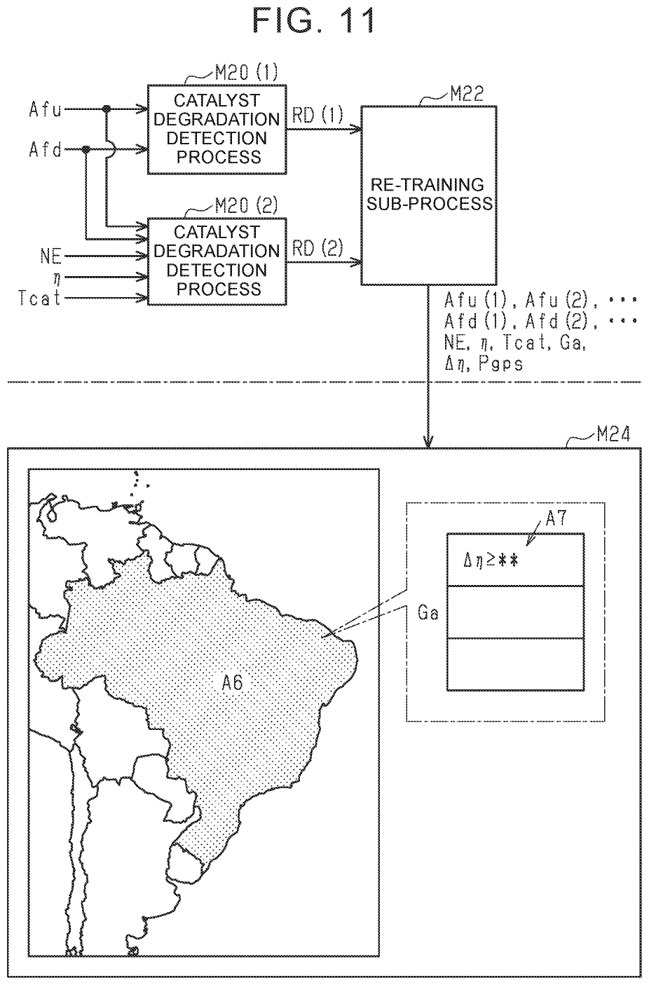

The service map data 76a and the evaluation map data 76b according to the present embodiment are pieces of data that define a map that outputs the value of a degradation variable RD indicating the degree of degradation of the catalyst 30. FIG. 11 shows a process that a learning system for a vehicle according to the present embodiment executes. The process shown in FIG. 11 includes a process that is implemented by the CPU 72 running a program stored in the ROM 74 and a process that is implemented by the CPU 122 running a program stored in the ROM 124.

A catalyst degradation detection process M20(1) is a process of calculating the value of a degradation variable RD(1) by using the service map data 76a. The catalyst degradation detection process M20(1) is a process of, at the timing at which the downstream air-fuel ratio Afd reverses from a lean side to a rich side, executing active control such that oxygen is excessively present in exhaust gas flowing into the catalyst 30 and calculating the value of the degradation variable RD(1) based on the amount of oxygen flowing into the catalyst 30 until the downstream air-fuel ratio Afd reverses from a rich side to a lean side.

A catalyst degradation detection process M20(2) is a process of calculating the value of a degradation variable RD(2) by using the evaluation map data 76b. The catalyst degradation detection process M20(2) is a process of calculating the value of the degradation variable RD(2) by using a neural network that uses time-series data of the upstream air-fuel ratio Afu of the catalyst 30, time-series data of the downstream air-fuel ratio Afd, the rotation speed NE, the charging efficiency η and the temperature of the catalyst 30 (catalyst temperature Teat) as inputs and outputs the degradation variable RD(2).catalyst The catalyst temperature Tcat may be, for example, a first-order lag value of the exhaust gas temperature Tex.

A re-training sub-process M22 includes a process of, when the absolute value of the difference between the value of the degradation variable RD(1) and the value of the degradation variable RD(2), calculated in the same trip, is greater than or equal to a predetermined value, determining that the determination result using the service map data 76a and the determination result using the evaluation map data 76b do not match. The re-training sub-process M22 includes a process of sending predetermined data to the data analysis center 120. Data to be sent includes the values of the input variables used to calculate the degradation variable RD at the time when both the determination results do not match. Data to be sent includes the upstream air-fuel ratios Afu and downstream air-fuel ratios Afd used to calculate the degradation variable RD at the time when both the determination results do not match and adjacent time-series data of the upstream air-fuel ratio Afu and adjacent time-series data of the downstream air-fuel ratio Afd. This is to make it possible to further accurately judge whether the degradation variable RD(2) is a correct value based on the behaviors of the upstream air-fuel ratio Afu and downstream air-fuel ratio Afd in the data analysis center 120.

Data to be sent includes the intake air volume Ga. This is because the behavior of the downstream air-fuel ratio Afd is susceptible to the intake air volume Ga, and is to check whether the accuracy of the degradation variable RD(2) significantly decreases depending on the value of the intake air volume Ga.

Data to be sent includes the amount of change Δη that is the difference between the local maximum and local minimum of the charging efficiency η in a predetermined time. This is because the air-fuel ratio of air-fuel mixture to be subjected to combustion in the combustion chambers 18 changes with a change in charging efficiency η and is to check whether the accuracy of the degradation variable RD(2) significantly decreases depending on the amount of change Δη.

Data to be sent includes the position data Pgps. This is because fuel properties, such as the concentration of alcohol in fuel, vary among regions and is to check whether the accuracy of the value of the degradation variable RD(2) significantly decreases depending on a region.

The CPU 122 executes processes similar to FIG. 4 and FIG. 6 as a re-training process M24. The process similar to the process of FIG. 4 includes a process of, when the absolute value of the difference between a value that is appropriate as the value of the degradation variable RD in the data analysis center 120 and the output value of the map defined by the evaluation map data 76b is greater than or equal to a predetermined value, determining that the output is an error. In the present embodiment, an example in which, subsequently to evaluation of the output error rate by regions, evaluation of the output error rate by areas partitioned based on the intake air volume Ga is performed will be described. FIG. 11 illustrates a case where the output error rate in vehicles located an area A6 is higher than or equal to a threshold because of a difference in output error rate based on the position data Pgps and, within the area A6, the output error rate is particularly high in one area A7 of three areas partitioned based on the intake air volume Ga. More specifically, an example in which the output error rate is particularly high in an area of which the amount of change Δη is greater than or equal to a predetermined amount in the area A7 is described. Therefore, the CPU 122 updates area A6-specific evaluation map data 76b separately based on whether the amount of change Δη is greater than or equal to the predetermined amount in the area A7 of the three areas partitioned based on the intake air volume Ga.

### Fourth Embodiment

Hereinafter, a fourth embodiment will be described with reference to the accompanying drawing with a focus on the difference from the first embodiment.

In the present embodiment, the catalyst 30 includes a filter that traps particulate matter (PM) is illustrated, and the service map data 76a and the evaluation map data 76b are data that defines a map that outputs a PM deposit amount DPM that is the amount of PM deposited in the filter.

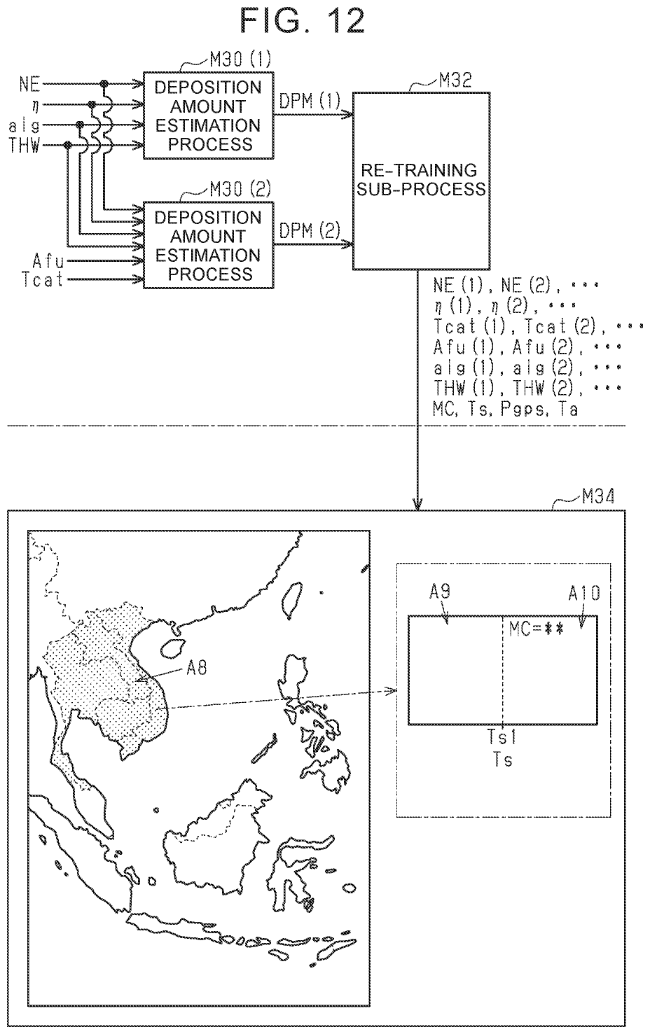

FIG. 12 shows a process that a learning system for a vehicle according to the present embodiment executes. The process shown in FIG. 12 includes a process that is implemented by the CPU 72 running a program stored in the ROM 74 and a process that is implemented by the CPU 122 running a program stored in the ROM 124.

A deposition amount estimation process M30(1) is a process of calculating the PM deposit amount DPM(1) by using the service map data 76a. The deposition amount estimation process M30(1) is a process of calculating a PM deposit amount DPM(1) by using map that determines the relationship between a base value of the PM deposit amount DPM and a pair of the rotation speed NE and the charging efficiency η, map data that determines the relationship between ignition timing aig and a correction amount for the PM deposit amount DPM, and map data that determines the relationship between a coolant temperature THW and a correction amount for the PM deposit amount DPM.

A deposition amount estimation process M30(2) is a process of calculating a PM deposit amount DPM(2) by using the evaluation map data 76b. The deposition amount estimation process M30(2) is a process of calculating the PM deposit amount DPM(2) by using a neural network that uses the rotation speed NE, the charging efficiency η, the upstream air-fuel ratio Afu, the catalyst temperature Tcat, the ignition timing aig, and the coolant temperature THW as inputs and outputs the amount of change in the PM deposit amount DPM(2).

A re-training sub-process M32 includes a process of, when the absolute value of the difference between the PM deposit amount DPM(1) and the PM deposit amount DPM(2) is greater than or equal to a predetermined value, determining that the determination result using the service map data 76a and the determination result using the evaluation map data 76b do not match. The re-training sub-process M32 also includes a process of sending time-series data, or the like, made up of input data used to calculate the PM deposit amount DPM(2) in a period from the startup of the internal combustion engine 10 to the time point at which a mismatch occurs, as data to be sent. The reason why time-series data is sent is to calculate a PM deposit amount DPM based on the time-series data and determine the validity of the PM deposit amount DPM(2) in the data analysis center 120.

The data to be sent includes the combustion control mode value MC. In the present embodiment, a value for identifying a mode based on the value of a target air-fuel ratio or a mode to increase the exhaust gas temperature for the process of regenerating the filter or the other modes is illustrated as the combustion control mode value MC. This is to check whether the accuracy of estimating the PM deposit amount DPM(2) varies depending on a difference in combustion control mode.

Data to be sent includes an elapsed time Ts from the startup of the internal combustion engine 10. This is because fuel easily adheres to a cylinder wall surface, or the like, and PM is easily produced just after the startup and is to check whether the accuracy of estimating the PM deposit amount DPM(2) varies between a period just after the startup and the other period.

Data to be sent includes the position data Pgps and the intake air temperature Ta. The reason to send these pieces of data is similar to the reason to send these pieces of data through the re-training sub-process M12. The CPU 122 executes processes similar to (b) of FIG. 4 and (b) of FIG. 6 as a re-training process M34. The process similar to the process of FIG. 4 includes a process of, when the absolute value of the difference between a value that is appropriate as the value of the PM deposit amount DPM in the data analysis center 120 and the output value of the map defined by the evaluation map data 76b is greater than or equal to a predetermined value, determining that the output is an error. In the present embodiment, an example in which, subsequently to evaluation of the output error rate by regions, evaluation of the output error rate by areas partitioned based on the elapsed time Ts is performed will be described. FIG. 12 illustrates a case where the output error rate in vehicles located an area A8 is higher than or equal to a threshold because of a difference in output error rate based on the position data Pgps and, within the area A8, the output error rate is particularly high in an area A9 in which the elapsed time Ts is shorter than or equal to a predetermined time Ts1. FIG. 12 illustrates that, even in an area in which the elapsed time Ts is longer than the predetermined time Ts1 but in the area A9 in which the combustion control mode value MC is a predetermined value, the output error rate is particularly high. Therefore, the CPU 122 updates area A8-specific evaluation map data 76b with different pieces of data based on whether a vehicle is located in the area in which the elapsed time Ts is shorter than or equal to the predetermined time Ts1, the area in which the elapsed time Ts is longer than the predetermined time Ts1 and the combustion control mode value MC is the predetermined value, or the other areas.

### Fifth Embodiment

Hereinafter, a fifth embodiment will be described with reference to the accompanying drawing with a focus on the difference from the first embodiment.

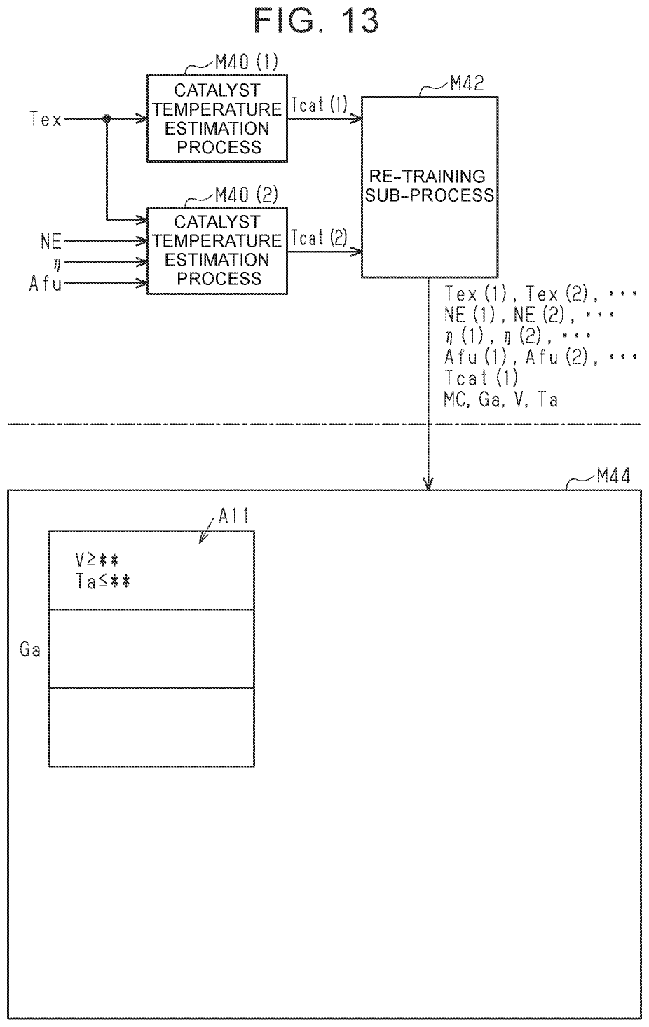

The service map data 76a and the evaluation map data 76b according to the present embodiment are pieces of data that define a map that outputs the temperature of the catalyst 30 (catalyst temperature Tcat). FIG. 13 shows a process that a learning system for a vehicle according to the present embodiment executes. The process shown in FIG. 13 includes a process that is implemented by the CPU 72 running a program stored in the ROM 74 and a process that is implemented by the CPU 122 running a program stored in the ROM 124.

A catalyst temperature estimation process M40(1) is a process of calculating a catalyst temperature Tcat(1) by using the service map data 76a. The catalyst temperature estimation process M40(1 is a process of executing first-order lag filtering that uses the exhaust gas temperature Tex as an input and uses the output value of the first-order lag filtering as the catalyst temperature Tcat(1).

A catalyst temperature estimation process M40(2) is a process of calculating a catalyst temperature Tcat(2) by using the evaluation map data 76b. The catalyst temperature estimation process M40(2) is a process of calculating the catalyst temperature Tcat(2) by using a neural network that uses time-series data of each of the exhaust gas temperature Tex, the rotation speed NE, the charging efficiency η, and the upstream air-fuel ratio Afu, and a last value of the catalyst temperature Tcat(2) as inputs.

A re-training sub-process M42 includes a process of, when the absolute value of the difference between the catalyst temperature Tcat(1) and the catalyst temperature Tcat(2) is greater than or equal to a predetermined value, determining that the determination result using the service map data 76a and the determination result using the evaluation map data 76b do not match. The re-training sub-process M42 includes a process of sending data to the data analysis center 120.

Data to be sent includes time-series data made up of input data used to calculate the catalyst temperature Tcat(2) in a period from the startup of the internal combustion engine 10 to the time point at which a mismatch occurs. The reason why time-series data is sent is to calculate a catalyst temperature Tcat based on the time-series data and determine the validity of the catalyst temperature Tcat(2) in the data analysis center 120.

Data to be sent includes the combustion control mode value MC. In the present embodiment, a value for identifying a mode based on the value of a target air-fuel ratio or a mode to increase the exhaust gas temperature for the process of regenerating the catalyst 30 or the other modes is illustrated as the combustion control mode value MC. This is to check the influence of a difference in combustion control mode on the accuracy of estimating the catalyst temperature Tcat(2).

Data to be sent includes the intake air volume Ga. This is because the amount of heat that the catalyst 30 and air exchange varies depending on the intake air volume Ga and is to check the influence of the intake air volume Ga on the accuracy of estimating the catalyst temperature Tcat(2).

Data to be sent includes the vehicle speed V. This is to check the influence of air flow while traveling on the accuracy of estimating the catalyst temperature Tcat(2). Data to be sent includes the intake air temperature Ta. The intake air temperature Ta is a substitute for an outside air temperature. This is because a heat gradient between the catalyst 30 and outside air varies according to an outside air temperature and is to check the influence of the outside air temperature on the accuracy of estimating the catalyst temperature Tcat(2).

The CPU 122 executes processes similar to (b) of FIG. 4 and (b) of FIG. 6 as a re-training process M44. The process similar to the process of FIG. 4 includes a process of, when the absolute value of the difference between a value that is appropriate as the value of the catalyst temperature Tcat in the data analysis center 120 and the output value of the map defined by the evaluation map data 76b is greater than or equal to a predetermined value, determining that the output is an error. In the present embodiment, an example in which evaluation of the output error rate by areas divided into three areas based on the intake air volume Ga is initially performed will be described. FIG. 13 illustrates a case where the output error rate is particularly high when the vehicle speed V is higher than or equal to a predetermined speed and the intake air temperature Ta is lower than or equal to a predetermined temperature in one area Al1 of the three areas divided based on the intake air volume Ga. Therefore, the CPU 122 updates specific evaluation map data 76b when the vehicle speed V is higher than or equal to the predetermined speed and the intake air temperature Ta is lower than or equal to the predetermined temperature in the area A11.

### Correspondence Relationship

Matters in the above-described embodiments may be regarded as the matters described in SUMMARY as follows. The processor may be regarded as the CPU 72 and the ROM 74. The memory may be regarded as the memory 76. The map data may be regarded as the evaluation map data 76b. The acquisition process may be regarded as S40 and S76. The calculation process may be regarded as S44 and S46. The sending process may be regarded as S82. The value of the position variable may be regarded as the position data Pgps. The value of the environment variable may be regarded as the intake air temperature Ta, the atmospheric pressure Pa, and the road surface condition value SR. The instantaneous speed may be regarded as the minute rotation time T30. The value of the rotation waveform variable may be regarded as the minute rotation times T30(1), T30(2), T30(3), T30(4), T30(5), T30(6), T30(7), T30(8), T30(9), T30(10), T30(11), T30(12), T30(13), T30(14), T30(15), T30(16), T30(17), T30(18), T30(19), T30(20), T30(21), T30(22), T30(23), T30(24). The value of the road surface condition variable may be regarded as the road surface condition value SR. The value of the operating status variable may be regarded as the combustion control mode value MC, the shift position Vsft, the vehicle speed V, or the rotation speed NE and the charging efficiency η in FIG. 10. The value of the mode variable may be regarded as the combustion control mode value MC. The value of the speed ratio variable may be regarded as the shift position Vsft. The value of the vehicle speed variable may be regarded as the vehicle speed V. The first map data may be regarded as the service map data 76a. The first acquisition process may be regarded as S10. The first calculation process may be regarded as S16 and S18. The determination process may be regarded as S64 or S70. The second processor may be regarded as the CPU 122 and the ROM 124. The reception process may be regarded as S90. The re-training data generation process may be regarded as S92, S94, S96, and S98. The re-training process may be regarded as S100, S102, S104, S106, S108, S110, S112, S114, S116, S118, and S120. The map data sending process may be regarded as S122. The map data reception process may be regarded as S132.

### Other Embodiments

The present embodiments may be modified as follows. The present embodiments and the following modifications may be implemented in combination without any technical contradiction.

### Prescribed Status of Vehicle

The prescribed status of the vehicle, of which information is included in the outputs of the map, is not limited to the ones illustrated in the above-described embodiments. For example, the status of the internal combustion engine may be as follows.

### (a) Status Regarding Degradation of Response of Air-Fuel Ratio Sensor

In this case, for a degradation determination process using the service map data 76a as the first map data, active control for significantly changing the air-fuel ratio alternately to a lean side and a rich side out of normal air-fuel ratio feedback control may be used. Then, the service map data 76a may be data to calculate the value of the degradation variable based on, for example, a time required for the upstream air-fuel ratio Afu to reverse from a rich side to a lean side or from a lean side to a rich side under active control. The evaluation map data 76b as the second map data may be data that defines a neural network that uses time-series data of the injection amount and time-series data of the upstream air-fuel ratio Afu as inputs and outputs the value of the degradation variable indicating the presence or absence of degradation. In this case, the process of calculating the value of the degradation variable by using the second map may be executed while active control is not being executed. Data to be sent from the vehicle to the data analysis center 120, other than input data, may include the rotation speed NE and the charging efficiency η. Thus, the data analysis center 120 is able to check whether there is a pair of operating point variables of which the output error rate is high.

### (b) Status Regarding Oxygen Storage Amount of Catalyst

In this case, the service map data 76a as the first map data may be map data that uses the difference between an average of the upstream air-fuel ratio Afu and an average of the downstream air-fuel ratio Afd as an input variable and uses the value of a storage amount variable that is a variable indicating an oxygen storage amount as an output variable. The evaluation map data 76b as the second map data may be data that defines a neural network that uses an integrated value of an excess and deficiency of an actual amount of fuel to an amount of fuel that reacts with oxygen in just proportion in a predetermined period, an integrated value of the temperature of the catalyst in the predetermined period, and a last value of the storage amount variable as inputs and outputs the value of the storage amount variable. Data to be sent from the vehicle to the data analysis center 120, other than input data, may include the flow rate of fluid inside the catalyst 30. Thus, the data analysis center 120 is able to check whether there is a flow rate of which the output error rate is high.

### (c) Status Regarding Presence or Absence of Knocking in Internal Combustion Engine

In this case, the service map data 76a as the first map data may be data that defines a map that outputs a logical value indicating whether there is knocking by comparing an integrated value of a detected value of a knocking sensor with a determination value. The evaluation map data 76b as the second map data may be data that defines a neural network that uses time-series data of a detected value of the knocking sensor as inputs and outputs a peak value of the pressure in each combustion chamber 18. In this case, when the peak value is higher than or equal to a threshold, it may be determined that knocking has occurred. Data to be sent from the vehicle to the data analysis center 120, other than input data, may include, for example, the rotation speed NE and the charging efficiency r. With this configuration, the CPU 122 is able to check whether there is an operating point area of which the output error rate is high.

(d) Status Regarding Temperature of Fuel that is Supplied to Fuel Injection Valves 20

In this case, the service map data 76a as the first map data may be map data that uses the rotation speed NE, the charging efficiency r, and the coolant temperature THW as input variables and uses the temperature of fuel as an output variable. The evaluation map data 76b as the second map data may be a map that defines a neural network that uses the rotation speed NE, the charging efficiency q, the amount of fuel injected by the fuel injection valves 20, the intake air temperature Ta, the vehicle speed V, and a last value of the temperature of fuel as inputs and outputs the temperature of fuel. Data to be sent from the vehicle to the data analysis center 120 may be the output values and input data of the neural network from the startup of the internal combustion engine 10. Thus, the data analysis center 120 is able to estimate changes in the temperature of fuel with time. Furthermore, data to be sent may include, for example, the ignition timing, the coolant temperature THW, or the like. With this configuration, the CPU 122 is able to check whether the output error rate is high in a specific area partitioned based on the ignition timing and the coolant temperature THW. Even when the output values and input data of the neural network from the startup of the internal combustion engine 10 are sent, the data analysis center 120 is able to check whether the output error rate is high in a specific area partitioned based on the operating point variables.

### (e) Presence or Absence of Abnormality in Purge System

In a purge system including a canister that traps fuel vapor in a fuel tank and a purge valve that adjusts the flow sectional area of a purge passage between the canister and the intake passage, it is conceivable that a map determines an abnormality when there is a hole in the purge passage. In this case, the service map data 76a as the first map data may be data that defines a map that outputs a logical value indicting an abnormality when the rate of increase in pressure at the time when the purge valve is closed after the pressure in the canister is decreased by opening the purge valve is higher than or equal to a threshold. The evaluation map data 76b as the second map data may be data that defines a neural network that uses time-series data of the pressure in the canister and the atmospheric pressure Pa as inputs and outputs an output value according to the presence or absence of a hole. Data to be sent from the vehicle to the data analysis center 120 may be not only the output value and input data of the neural network but also a fuel level in the fuel tank. Thus, the influence of the fuel level on the accuracy of the output value can be checked.

### (f) EGR Rate

An EGR rate is the percentage of the flow rate of fluid flowing from the EGR passage 32 to the intake passage 12 to the flow rate of fluid flowing from the intake passage 12 to the combustion chambers 18. In this case, the service map data 76a as the first map data may be map data that uses the rotation speed NE and the charging efficiency r as input variables and uses the EGR rate as an output variable. The evaluation map data 76b as the second map data may be data that defines a neural network that uses the rotation speed NE, the charging efficiency r, the pressure in the intake passage 12, and the intake air volume Ga as input variables and outputs the EGR rate.

In this case, data to be sent from the vehicle to the data analysis center 120 may include, for example, not only input data used to calculate the EGR rate at the time when a mismatch occurs but also the atmospheric pressure Pa, the intake air temperature Ta, and the coolant temperature THW. Thus, the influence of the atmospheric pressure Pa, the intake air temperature Ta, or the coolant temperature THW on the accuracy of the output value can be checked.

(g) Status regarding Presence or Absence of Leakage of from Blow-by Gas Delivery Passage

Here, it is assumed that a blow-by gas delivery passage that connects the crankcase and intake passage 12 of the internal combustion engine 10 is provided. In this case, a pressure sensor may be provided in the blow-by gas delivery passage, and the service map data 76a as the first map data may be data that outputs a value indicating the presence or absence of an abnormality by comparing the pressure detected by the pressure sensor with a determination value based on the rotation speed NE and the charging efficiency q. The evaluation map data 76b as the second map data may be data that defines a neural network that uses the rotation speed NE, the charging efficiency r, and the difference between the intake air volume Ga and the amount of intake air passing through the throttle valve 14 as input variables and outputs a value indicating the presence or absence of an abnormality.

In this case, by sending the input data used to calculate the value indicating the presence or absence of an abnormality at the time when a mismatch occurs from the vehicle to the data analysis center 120, for example, the influence of the pair of operating point variables on the accuracy of the output value can be checked. Data to be sent may include data adjacent in time series to the input data used to calculate the value indicating the presence or absence of an abnormality at the time when a mismatch occurs. Thus, the validity of the output value can be highly accurately checked.

The prescribed status of the vehicle is not limited to the status of the internal combustion engine. For example, as described in the following section “Vehicle”, for a vehicle including a rotating electrical machine, the prescribed status of the vehicle may be the status of a battery that stores an electric power that is supplied to the rotating electrical machine.

### Sending Process

### (a) In Case of Misfire

In the process of FIG. 4, time-series data of the minute rotation time T30 for three combustion cycles is sent; however, data to be sent is not limited thereto. For example, time-series data for two combustion cycles, that is, the minute rotation times T30(25), T30(26), T30(27), T30(28), T30(29), T30(30), T30(31), T30(32), T30(33), T30(34), T30(35), T30(36), T30(37), T30(38), T30(39), T30(40), T30(41), T30(42), T30(43), T30(44), T30(45), T30(46), T30(47), T30(48) at the time when the determination result using the service map data 76a and the determination result using the evaluation map data 76b do not match and the minute rotation times T30(49), T30(50), T30(51), T30(52), T30(53), T30(54), T30(55), T30(56), T30(57), T30(58), T30(59), T30(60), T30(61), T30(62), T30(63), T30(64), T30(65), T30(66), T30(67), T30(68), T30(69), T30(70), T30(71), T30(72) after a transition from the state where it is determined as not matching to a state where it is determined as matching, may be sent.

In the process of FIG. 4, not only the minute rotation times T30(25), T30(26), T30(27), T30(28), T30(29), T30(30), T30(31), T30(32), T30(33), T30(34), T30(35), T30(36), T30(37), T30(38), T30(39), T30(40), T30(41), T30(42), T30(43), T30(44), T30(45), T30(46), T30(47), T30(48) at the time when the determination result using the service map data 76a and the determination result using the evaluation map data 76b do not match but also the minute rotation times T30(49), T30(50), T30(51), T30(52), T30(53), T30(54), T30(55), T30(56), T30(57), T30(58), T30(59), T30(60), T30(61), T30(62), T30(63), T30(64), T30(65), T30(66), T30(67), T30(68), T30(69), T30(70), T30(71), T30(72) after a transition from the state where it is determined as not matching to the state where it is determined as matching are sent; however, data to be sent is not limited thereto. For example, time-series data of the minute rotation time T30 in a state where it is determined as matching and time-series data of the minute rotation time T30 after a transition from the state where it is determined as matching to a state where it is determined as not matching may be sent.

Of time-series data to be sent, time-series data of the minute rotation time T30 after a transition into the state where it is determined as matching is not limited to time-series data for one combustion cycle. For example, as described in the section “Second Map Data”, when an output value resulting from an input once is only the value of a misfire variable of one of the cylinders and input data itself is time-series data of the minute rotation time T30 in a period shorter than one combustion cycle, time-series data of an amount appropriate for the time-series data may be sent. It is not indispensable that time-series data of the minute rotation time T30, which make up the input variables to the map, and time-series data of the minute rotation time T30 after a transition into the state where it is determined as matching both are the minute rotation times T30 in a section having the same length.

In the process of FIG. 4, time-series data of the minute rotation time T30 for three combustion cycles, associated with the time when the number of times successively determined as not matching is maximum, is sent once a trip; however, data to be sent is not limited thereto. For example, all the minute rotation times T30 in a period in which it is successively determined as not matching, associated with the time when the number of times successively determined as not matching is maximum, and time-series data for one combustion cycle of the minute rotation time T30 after a transition from the state where it is determined as not matching to the state where it is determined as matching may be sent once a trip. Alternatively, for example, all the minute rotation times T30 in a period in which it is determined as not matching and time-series data for one combustion cycle of the minute rotation time T30 after a transition from the state where it is determined as not matching to the state where it is determined as matching for each of minute rotation times T30 in that period may be sent once a trip.

Of data to be sent, data other than the input data to the map and the minute rotation times T30 is not limited to the ones illustrated in the extra information group GrE.

### (b) General Configuration

Data on the output value of the second map defined by the second map data at the time when it is determined as not matching, which is to be sent, is not limited to the output value of the second map itself. For example, in the process of FIG. 4, the output value of the map defined by the service map data 76a may be sent. In this case, for example, when an expert judges in S92 and S94 that the output value of the map defined by the service map data 76a is correct, affirmative determination may be made in S96. Even when such data is not sent, but when input data is sent, the data analysis center 120 is able to calculate the output value of the map defined by the evaluation map data 76b.

### First Map, First Map Data

In FIG. 1, and FIG. 10 to FIG. 13, data for which a determination value, or the like, is adapted is illustrated as the service map data 76a serving as the first map data without using machine learning; however, the configuration is not limited thereto. The first map data may be, for example, data that defines a neural network having a smaller number of dimensions of input variables than the neural network defined by the evaluation map data 76b as the second map data. It is not indispensable that the number of dimensions of inputs of the first map is smaller than the number of dimensions of inputs of the second map. For example, the number of dimensions of inputs may be the same, and the number of intermediate layers may be less than the number of intermediate layers of the second map. Alternatively, for example, both the number of dimensions of inputs and the number of intermediate layers may be the same as those of the second map, and the activation functions may be different from each other.

A function approximator as a trained model trained through machine learning is not limited to a neural network. For example, when information about a status is expressed by three or more values, regression equation, or the like, may be used. When a determination value indicating that a normal state or an abnormal state is output, a discriminant function may be used. A regression equation here is not limited to the one equivalent to the neural network from which the intermediate layer is omitted and may be the one using, for example, a kernel function. A discriminant function may be the one that uses an output value of a logistic sigmoid function, which uses an output of the regression equation as an independent variable, as an output value.

### Second Map Data

### (a) General Configuration

The evaluation map data 76b as the second map data is not limited to data that defines a neural network having a single intermediate layer. For example, the second map data may be data that defines a neural network having two or more intermediate layers. The activation function hl is not limited to a hyperbolic tangent and may be, for example, a logistic sigmoid function or an ReLU. The ReLU is a function that outputs a value that is not a smaller one of an input value and “0”.

A function approximator as a trained model trained through machine learning is not limited to a neural network. For example, when information about a status is expressed by three or more values, regression equation, or the like, may be used. When a determination value indicating that a normal state or an abnormal state is output, a discriminant function may be used. A regression equation here is not limited to the one equivalent to the neural network from which the intermediate layer is omitted and may be the one using, for example, a kernel function. A discriminant function may be the one that uses an output value of a logistic sigmoid function, which uses an output of the regression equation as an independent variable, as an output value.

### (b) In Case of Misfire Detection

The number of nodes, that is, dimensions, of the output layer of the neural network is not limited to “(Number of cylinders)+1”. For example, the number of nodes of the output layer may be equal to the number of the cylinders, and, it may be determined that a misfire has occurred when any one of output values exceeds a threshold. Alternatively, for example, the number of cylinders to be determined as to the presence or absence of misfire based on a single output of the neural network may be one, and the number of nodes of the output layer may be one. In this case, the output layer is desirably configured such that the range of a value that the output value can take on is normalized by a logistic sigmoid function, or the like.

### Re-Training Process

In the above-described embodiments, when the evaluation map data 76b that is used only in a certain area is trained, only training data for that area is used; however, the configuration is not limited thereto. For example, at the time of re-training the evaluation map data 76b that is used in the areas other than the area A1 of FIG. 7, training data for the area A1 may be mixed at a predetermined ratio.

In the above-described embodiments, divided areas of which the output error rate is lower than a threshold may be united as one common area. In other words, for example, when the output error rate is lower than the threshold Rth1 in the areas other than the area A2 of FIG. 8 within the area A1 of FIG. 7, only two, that is, the area A2-specific evaluation map data 76b for the area A1 and the evaluation map data 76b for all the other area, may be updated separately.

For example, the order of creating the distribution of the output error rate is not limited to the ones illustrated in the above-described embodiments. Furthermore, for example, when an area is divided based on the values of some variables, it may be determined whether the output error rate is higher than or equal to a threshold for each divided areas, and finally the variables that provide the minimum number of the sum of the areas of which the output error rate is higher than or equal to the threshold and the areas of which the output error rate is not higher than or equal to the threshold may be employed.

In the above-described configuration, classification of the output error rate based on the position data Pgps is performed by countries or prescribed regions divided from a country; however, the configuration is not limited thereto. For example, classification may be performed by countries only or, for example, classification may be performed by regions larger than countries. Conversely, classification may be performed by regions divided from countries only.

Furthermore, for example, division may be performed by using a statistical method. For example, classification may be performed by using a clustering method, such as K-means. Alternatively, for example, an output error distribution may be approximated by a mixture gaussian distribution that is a linear combination of gaussian distributions of which the average is the center of an output error distribution, and an area may be divided by using the mixture gaussian distribution. In other words, a mixing coefficient, average, and variance of the mixture gaussian distribution is trained based on position data Pgps from which an error is output, and an area may be divided by areas of which the value of one gaussian distribution is greater than the others. An application target of the statistical method is not limited to classification of the output error rate based on the position data Pgps and may be, for example, classification of the output error rate based on the value of the environment variable such as the intake air temperature Ta or classification of the output error rate based on the value of the operating status variable such as the combustion control mode value MC.

In the above-described embodiments, the description does not refer to at what percentage of areas of which the output error rate is higher than or equal to the threshold, a dividing process is executed. When the percentage of areas of which the output error rate is higher than or equal to the threshold is high, the value of the variable may not contribute to a decrease in output error rate, so the dividing process is desirably executed when the percentage is lower than or equal to a predetermined value. The distribution of output error rate, which is referenced at the time of the dividing process, may be a histogram that represents a relative output error rate of each rank where divided areas are ranks, instead of quantification as the percentage of the absolute number of output errors.

The configuration is not limited to the case where map data to be used, which has not been divided by areas, is newly divided. For example, when map data to be used has been divided by areas from the beginning, the validity of the division may be checked. In this case, the area may be changed based on the checked result.

The configuration is not limited to the configuration in which the area in which map data is used is changed. For example, data may be added to input variables to the map. In other words, for example, in the process of FIG. 6, when the output error rate is high in at least one of areas divided based on the intake air temperature Ta, the intake air temperature Ta may be added to the input variables.

Furthermore, it is not indispensable that the evaluation map data 76b is divided or an input variable is added to the map defined by the data. Only a single set of the evaluation map data 76b may be updated by using all the re-training data 126a without increasing the dimensions of the input variables.

### Environment Variable

The environment variable that is used to check the validity of the map defined by the evaluation map data 76b is not limited to the ones illustrated in the above-described embodiments. For example, the environment variable may be a variable that indicates the weather around the vehicle VC1, or a wind speed. Particularly, for the catalyst temperature Tcat, or the like, the heat radiation condition of the catalyst 30 is affected by a wind speed, so it is effective to those variables. The value of a variable that indicates the weather or the value of a variable that indicates a wind speed may be sent from the vehicle VC1. Alternatively, the data analysis center 120 may acquire the values of those variables from an institution that provides information, or the like, on the weather based on the position data Pgps of the vehicle VC1.

### Variable Indicating Operating Status

The variable that indicates an operating status that is used to check the validity of the map defined by the evaluation map data 76b is not limited to the ones illustrated in the above-described embodiments. Particularly, for the combustion control mode value MC, not limited to the above-described partitions, for example, partitions used in one of the above-described embodiments may be applied to the other embodiments.

### Related Data

The method of using the related data different from the input data is not limited to dividing an area in which the evaluation map data 76b is used or being set as a candidate to be added to input variables. For example, the related data may be only used to determine the validity of the output value of the map defined by the evaluation map data 76b. This is, for example, implemented by incorporating an in-vehicle sensor that detects the value of a variable related to the output value of the map defined by the evaluation map data 76b into the in-vehicle sensors. Specifically, for the map that outputs the peak value of the pressure in each combustion chamber 18, described in (c) of “Prescribed Status of Vehicle”, a sensor that detects the pressure in each combustion chamber 18 may be included in the in-vehicle sensors.

For example, as will be described in the section “Process of Determining Validity of Output Value of Map”, a method of using the related data is implemented by using the related data as an input to a map having a higher accuracy than the map defined by the service map data 76a.

### Operation Process Based on Output Value of Map Defined by First Map Data

The notification process of operating the alarm lamp 104 installed in the vehicle is illustrated as the operation process of operating predetermined hardware based on the output value of the map defined by the first map data in the above-described embodiments; however, the notification process is not limited thereto. The notification process may be, for example, a process of operating the communication instrument 77 to cause a user's mobile terminal to display information that an abnormality has occurred.

The operation process is not limited to the notification process. The operation process may be, for example, a process of operating the operating parts for controlling combustion of air-fuel mixture in the combustion chambers 18 of the internal combustion engine 10 according to information that a misfire has occurred. Alternatively, for example, as shown in FIG. 10, when the evaluation map data 76b is the map that outputs the determination result as to the presence or absence of imbalance abnormality, the operation process may be a process of operating the fuel injection valves such that the imbalance abnormality is reduced. Alternatively, for example, as shown in FIG. 12, when the evaluation map data 76b is the map that outputs the amount of PM, the operation process may be a process of burn and remove PM by operating the operating parts of the internal combustion engine 10 for increasing the temperature of the filter. Alternatively, for example, as shown in FIG. 13, when the evaluation map data 76b is the map that outputs the temperature of the catalyst 30, the operation process may be a process off operating the operating parts of the internal combustion engine for increasing the temperature of the catalyst 30. The operation process in this case may be, for example, the process of regenerating the catalyst.

### Determination Process

The checking period in S60 is not limited to the ones illustrated in the above-described embodiments. In the process of FIG. 4, only in the checking period, it is determined whether the misfire determination result based on the service map data 76a and the misfire determination result based on the evaluation map data 76b match or do not math; however, the timing of the determination process is not limited thereto. For example, the determination process may be constantly executed.

### Re-Trained Parameter

In FIG. 6, the re-trained parameters that are the updated parameters are sent to the vehicles VC1, VC2, . . . via the network 110; however, the configuration is not limited thereto. For example, the re-trained parameters may be sent to dealers for vehicles, and data in the memory 76 may be updated when the vehicles VC1, VC2, . . . enter the dealers. In this case as well, the reliability of the evaluation map data 76b updated with the re-trained parameters can be further evaluated and updated.

It is not indispensable that the re-trained parameters do not need to be provided to the vehicle that has provided data to be used for re-training. The evaluation map data 76b may be updated by using the re-trained parameters, and the updated evaluation map data 76b may be only installed in a newly developed vehicle. In this case, in the case of the map that outputs the output value indicating information about the status of the internal combustion engine 10, the difference between the displacement of an internal combustion engine mounted on the newly developed vehicle and the displacement of the internal combustion engine mounted on the vehicle that has sent data for re-training is desirably less than or equal to a predetermined amount. As in the case of the above-described embodiments, when evaluation map data outputs a misfire variable based on the probability that a misfire has occurred in each of the cylinders, the number of cylinders of an internal combustion engine mounted on the newly developed vehicle is desirably the same as the number of cylinders of the internal combustion engine mounted on the vehicle that has sent data for re-training.

Furthermore, in FIG. 6, after the evaluation map data 76b is updated by using the re-trained parameters, the service map data 76a may be overwritten by the updated evaluation map data 76b.

### Display Device

In the above-described embodiments, the display device 112 is located in the data analysis center 120; however, the location of the display device 112 is not limited thereto. The display device 112 may be located at a hub different from a hub in which the memory 126, and the like, are located.

### Process of Determining Validity of Output Value of Map

In FIG. 4, the input data used to calculate the misfire variable P(j) calculated by using the evaluation map data 76b, and the related data are displayed on the display device 112, and an expert evaluates whether the determination is wrong; however, the configuration is not limited thereto. For example, evaluation may be performed by using map data having a higher accuracy of determining a misfire than the map defined by the service map data 76a. This may be, for example, a neural network that uses all the elements of rotation time group TrT30 and extra information group GrE received in S90 as input variables or a further larger number of elements as input variables and uses a misfire variable as an output variable. In this case, the number of intermediate layers is desirably greater than the number of intermediate layers of the neural network defined by the evaluation map data 76b.

It is not indispensable that the validity of the determination result of the map defined by the evaluation map data 76b is judged by using a subject having a higher accuracy than the map defined by the evaluation map data 76b or the service map data 76a. For example, the validity of the determination result of the map defined by the evaluation map data 76b may be judged based on majority rule among the determination result defined by the evaluation map data 76b and the determination results made by two or more other maps. Alternatively, for example, one of the determination results made by the two or more other maps may be replaced with a judgement made by an expert.

In the process of FIG. 4, for the sake of convenience of description, each time S82 is executed, S92 is executed; however, the configuration is not limited thereto. For example, S92 may be executed at the time point at which the accumulated amount of data determined as not matching has reached aa predetermined amount. Alternatively, for example, Data determined as not matching may be accumulated each time, and S92 may be executed in response to a request from an expert.

After the process of determining whether the output value of the map defined by the service map data 76a as the first map data and the output value of the map defined by the evaluation map data 76b match, when it is determined as not matching, the validity is checked by using another method; however, the configuration is not limited thereto. For example, with the process of determining whether the output value of the map defined by the service map data 76a or the output value of a map having a higher accuracy than that map and the output value of the map defined by the evaluation map data 76b match, when it is determined as not matching, it may be determined that the output value of the map defined by the evaluation map data 76b is not valid.

### Sharing of Roles in Learning System for Vehicle

For example, the service map data 76a as the first map data is stored in the memory 76, but the evaluation map data 76b as the second map data may be stored in the memory 126, and the CPU 122 may execute the process of FIG. 3. In this case, the process of FIG. 4 may be, for example, changed as follows.

1. The CPU 72 sends input data to the map defined by the evaluation map data 76b to the CPU 122. The CPU 122 sends the output value of the map to the CPU 72. The CPU 72 determines whether the output value of the map defined by the service map data 76a and the output value of the map defined by the evaluation map data 76b match. When the CPU 72 determines that the output values do not match, the CPU 72 sends related data.

2. The CPU 72 sends, to the CPU 122, the output value of the map defined by the service map data 76a in addition to the input data to the map defined by the evaluation map data 76b. The CPU 122 determines whether the output value of the map defined by the service map data 76a and the output value of the map defined by the evaluation map data 76b match. When the CPU 122 determines that the output values do not match, the CPU 122 may make a request of the CPU 72 to send the related data other than the input data.

For example, a learning system for a vehicle may be made up of not only the CPU 122 and the ROM 124 but also a CPU and a ROM provided in a mobile terminal. This is, for example, implemented by executing the process of FIG. 3 on the mobile terminal and sending the result of the process to the control apparatus 70 in the first embodiment.

### Learning Apparatus for Vehicle

A learning apparatus for a vehicle may be made up of a mobile terminal instead of the data analysis center 120. This is, for example, implemented by storing data, or the like, that defines a map having a higher accuracy than service map data described in the section “Process of Determining Validity of Output Value of Map” in a memory of the mobile terminal and executing a process similar to (b) of FIG. 4 and the process of (b) of FIG. 6 on the mobile terminal. In this case, only data related to the vehicle VC1 may be sent to the mobile terminal of a user of the vehicle VC1.

### Configuration of Processor

The processor is not limited to the one that includes the CPU 72 (102) and the ROM 74 (104) and that executes software processing. The processor may include, for example, an exclusive hardware circuit (for example, an ASIC, or the like) that performs hardware processing on at least part of the one subjected to software processing in the above-described embodiments. In other words, the processor may be configured as any one of the following (a) to (c).

(a) The processor includes a processing unit that executes all the processes in accordance with a program and a program storage device, such as a ROM, that stores the program.
(b) The processor includes a processing unit that executes part of the processes in accordance with a program, a program storage device that stores the program, and an exclusive hardware circuit that executes the remaining processes.
(c) The processor includes an exclusive hardware circuit that executes all the processes. A plurality of the software processors each including a processing unit and a program storage device, or a plurality of the exclusive hardware circuits may be provided.

### Memory

In the above-described embodiments, the memory 76 in which the evaluation map data 76b and the service map data 76a are stored and the ROM 74 that is a memory in which the re-training sub-program 74b is stored are different memories; however, the configuration is not limited thereto. For example, the memory 126 in which the re-training data 126a is stored and the ROM 124 that is a memory in which the re-training main program 124a is stored are different memories; however, the configuration is not limited thereto.

### Internal Combustion Engine

In the above-described embodiments, a direct injection valve that injects fuel into an associated one of the combustion chambers 18 is illustrated as the fuel injection valve; however, the configuration is not limited thereto. For example, a port injection valve that injects fuel into the intake passage 12 may be used instead. Alternatively, for example, both the port injection valve and each direct injection valve may be provided.

The internal combustion engine is not limited to a spark-ignition internal combustion engine and may be, for example, a compression-ignition internal combustion engine that uses light oil, or the like, as fuel. It is not indispensable that the internal combustion engine makes up part of a drivetrain. The internal combustion engine may be, for example, mounted on a so-called series hybrid vehicle in which a crankshaft is mechanically coupled to an in-vehicle generator and transmission of power is disconnected from the drive wheels 60.

### Vehicle

The vehicle is not limited to a vehicle of which a device that generates propelling force for the vehicle is only an internal combustion engine and may be, for example, a parallel hybrid vehicle or a series-parallel hybrid vehicle other than the series hybrid vehicle described in the section “Internal Combustion Engine”. In addition, the vehicle may be an electric vehicle on which no internal combustion engine is mounted.

### Others

A drivetrain device interposed between the crankshaft and the drive wheels is not limited to a stepped transmission and may be, for example, a continuously variable transmission.

What is claimed is:

1. A control apparatus for a vehicle, the control apparatus comprising:
a memory configured to store map data, the map data including data that defines a map and that have been trained through machine learning, the map being configured to use input data based on a detected value of an in-vehicle sensor as an input and output an output value having information about a prescribed status of the vehicle; and
a processor configured to execute an acquisition process of acquiring the input data and related data different from the input data,
the processor being configured to execute a calculation process of calculating the output value by using the input data, acquired through the acquisition process, as an input to the map, and
the processor being configured to execute a sending process of sending, to an outside of the vehicle, the input data used to calculate the output value and the related data acquired through the acquisition process together with the input data.

2. The control apparatus according to claim 1, wherein the related data includes a value of a positional information variable that is a variable indicating positional information of the vehicle.

3. The control apparatus according to claim 1, wherein the related data includes a value of an environment variable that is a variable indicating an environment around the vehicle.

4. The control apparatus according to claim 3, wherein:
the vehicle includes an internal combustion engine;
the prescribed status is a status of the internal combustion engine; and
the environment variable includes an intake air temperature variable that is a variable indicating an intake air temperature.

5. The control apparatus according to claim 3, wherein:
the vehicle includes an internal combustion engine;
the prescribed status is a status of the internal combustion engine; and
the environment variable includes an atmospheric pressure variable that is a variable indicating an atmospheric pressure.

6. The control apparatus according to claim 3, wherein:
the vehicle includes an internal combustion engine;
the in-vehicle sensor includes a crank angle sensor;
the input data includes a value of a rotation waveform variable that is a variable containing information about a difference between values of instantaneous speeds in different angular intervals that are less than an interval of appearance of a compression top dead center of the internal combustion engine, the instantaneous speeds each being a rotation speed of a crankshaft of the internal combustion engine in an associated one of the angular intervals; and
the environment variable includes a road surface condition variable indicating a condition of a road surface on which the vehicle is traveling.

7. The control apparatus according to claim 1, wherein the related data includes a value of an operating status variable that is a variable indicating an operating status of the vehicle.

8. The control apparatus according to claim 7, wherein:
the vehicle includes an internal combustion engine; and
the operating status variable includes a mode variable that is a variable indicating a combustion control mode of the internal combustion engine.

9. The control apparatus according to claim 7, wherein:
the vehicle includes an internal combustion engine and a transmission configured to change a speed ratio that is a ratio of an output-side rotation speed to a rotation speed of a crankshaft of the internal combustion engine;
the in-vehicle sensor includes a crank angle sensor; and
the operating status variable includes a speed ratio variable that is a variable indicating a speed ratio of the transmission.

10. The control apparatus according to claim 8, wherein:
the vehicle includes a transmission configured to change a speed ratio that is a ratio of an output-side rotation speed to a rotation speed of a crankshaft of the internal combustion engine;
the in-vehicle sensor includes a crank angle sensor; and
the operating status variable includes a speed ratio variable that is a variable indicating a speed ratio of the transmission.

11. The control apparatus according to claim 7, wherein:
an internal combustion engine including a catalyst in an exhaust passage is mounted on the vehicle;
information about the prescribed status is information about a temperature of the catalyst; and
the operating status variable includes a vehicle speed variable that is a variable indicating a travel speed of the vehicle.

12. The control apparatus according to claim 1, wherein:
the map is a second map;
the map data is second map data;
the input data is second input data;
the output value is a second output value;
the acquisition process is a second acquisition process;
the calculation process is a second calculation process;
the memory is configured to store first map data that is data that defines a first map, the first map uses first input data based on a detected value of the in-vehicle sensor as an input and outputs a first output value that is an output value containing information about the prescribed status;
the processor is configured to execute a first acquisition process of acquiring the first input data based on the detected value of the in-vehicle sensor;
the processor is configured to execute a first calculation process of calculating the first output value by using the first input data acquired through the first acquisition process as an input to the first map;
the processor is configured to execute a determination process of determining whether the first output value and the second output value match; and
the processor is configured to execute the sending process when the processor determines through the determination process that the first output value and the second output value do not match.

13. The control apparatus according to claim 4, wherein:
the map is a second map;
the map data is second map data;
the input data is second input data;
the output value is a second output value;
the acquisition process is a second acquisition process;
the calculation process is a second calculation process;
the memory is configured to store first map data that is data that defines a first map, the first map uses first input data based on a detected value of the in-vehicle sensor as an input and outputs a first output value that is an output value containing information about the prescribed status;
the processor is configured to execute a first acquisition process of acquiring the first input data based on the detected value of the in-vehicle sensor;
the processor is configured to execute a first calculation process of calculating the first output value by using the first input data acquired through the first acquisition process as an input to the first map;
the processor is configured to execute a determination process of determining whether the first output value and the second output value match; and
the processor is configured to execute the sending process when the processor determines through the determination process that the first output value and the second output value do not match.

14. The control apparatus according to claim 11, wherein:
the map is a second map;
the map data is second map data;
the input data is second input data;
the output value is a second output value;
the acquisition process is a second acquisition process;
the calculation process is a second calculation process;
the memory is configured to store first map data that is data that defines a first map, the first map uses first input data based on a detected value of the in-vehicle sensor as an input and outputs a first output value that is an output value containing information about the prescribed status;
the processor is configured to execute a first acquisition process of acquiring the first input data based on the detected value of the in-vehicle sensor;
the processor is configured to execute a first calculation process of calculating the first output value by using the first input data acquired through the first acquisition process as an input to the first map;
the processor is configured to execute a determination process of determining whether the first output value and the second output value match; and
the processor is configured to execute the sending process when the processor determines through the determination process that the first output value and the second output value do not match.

15. A learning system for a vehicle, the learning system comprising:
a memory configured to store map data, the map data including data that defines a map and that have been trained through machine learning, the map being configured to use input data based on a detected value of an in-vehicle sensor as an input and output an output value having information about a prescribed status of the vehicle;
a first processor configured to execute an acquisition process of acquiring the input data and related data different from the input data,
the first processor being configured to execute a calculation process of calculating the output value by using the input data, acquired through the acquisition process, as an input to the map, and
the first processor being configured to execute a sending process of sending, to an outside of the vehicle, the input data used to calculate the output value and the related data acquired through the acquisition process together with the input data; and
a second processor different from an in-vehicle device, wherein:
the second processor is configured to execute a reception process of receiving data sent by the first processor through the sending process;
the second processor is configured to execute a re-training data generation process of generating re-training data based on the data received through the reception process, the re-training data is data for re-training the map; and
the second processor is configured to execute a re-training process of re-training the map data based on the re-training data generated through the re-training data generation process.

16. The learning system according to claim 15, wherein:
the second processor is configured to execute a map data sending process of sending the map data re-trained through the re-training process to the vehicle; and
the first processor is configured to execute a map data reception process of receiving the map data sent by the second processor through the map data sending process.

17. A control method for a vehicle, the control method comprising:
storing map data by a memory, the map data including data that defines a map and that have been trained through machine learning, the map being configured to use input data based on a detected value of an in-vehicle sensor as an input and output an output value having information about a prescribed status of the vehicle; and
executing, by a processor, an acquisition process of acquiring the input data and related data different from the input data;
executing, by the processor, a calculation process of calculating the output value by using the input data, acquired through the acquisition process, as an input to the map; and
executing, by the processor, a sending process of sending, to an outside of the vehicle, the input data used to calculate the output value and the related data acquired through the acquisition process together with the input data.

18. The control method according to claim 17, wherein the related data includes a value of a positional information variable that is a variable indicating positional information of the vehicle.

19. The control method according to claim 17, wherein the related data includes a value of an environment variable that is a variable indicating an environment around the vehicle.

20. The control method according to claim 17, wherein:
the map is a second map;
the map data is second map data;
the input data is second input data;
the output value is a second output value;
the acquisition process is a second acquisition process; and
the calculation process is a second calculation process, the control method further comprising:
storing, by the memory, first map data that is data that defines a first map, the first map uses first input data based on a detected value of the in-vehicle sensor as an input and outputs a first output value that is an output value containing information about the prescribed status;
executing, by the processor, a first acquisition process of acquiring the first input data based on the detected value of the in-vehicle sensor;
executing, by the processor, a first calculation process of calculating the first output value by using the first input data acquired through the first acquisition process as an input to the first map;
executing, by the processor, a determination process of determining whether the first output value and the second output value match; and
executing, by the processor, the sending process when the processor determines through the determination process that the first output value and the second output value do not match.
